(19) United States
(12) Patent Application Publication
(10) Pub. No.: US 2026/0072940 A1
(43) Pub. Date: Mar. 12, 2026

(54) DISTRIBUTED DATABASE FOR MASSIVE-SCALE VIRTUAL WORLDS

(71) Applicant: Roblox Corporation, San Mateo, CA (US)

(72) Inventors: Andreas HAEBERLEN, Philadelphia (PA); Linh Thi XUAN PHAN, San Mateo, CA (US); Morgan Samuel McGUIRE, Vancouver (CA)

(73) Assignee: Roblox Corporation, San Mateo, CA (US)

(21) Appl. No.: 19/264,678

(22) Filed: Jul. 9, 2025

Related U.S. Application Data
(60) Provisional application No. 63/669,287, filed on Jul. 10, 2024.

(51) Int. Cl. G06F 16/27; G06F 16/22; G06F 16/23

(52) U.S. Cl. CPC G06F 16/27; G06F 16/2282; G06F 16/2379

(57) ABSTRACT

A computer-implemented method includes obtaining, by a processor, an initial version of a set of tables associated with a region of a virtual experience. Each row contains information associated with a virtual object located in a corresponding portion of the region. The method includes simulating, by the processor, the initial frame of the region of the virtual experience based at least in part on the initial version of the set of tables. The method includes generating, by the processor, an updated version of the set of tables associated with the region based on one or more first changes to a first virtual object in the region of the virtual experience. The method includes simulating, by the processor, the subsequent frame of the region of the virtual experience based at least in part on the updated version of the set of tables.

### CROSS-REFERENCE TO RELATED APPLICATIONS

This application is a non-provisional application that claims priority under 35 U.S.C. § 119(e) to U.S. Provisional Patent Application No. 63/669,287, filed on Jul. 10, 2024, the contents of which are hereby incorporated by reference herein in its entirety.

### TECHNICAL FIELD

Embodiments relate generally to online virtual experience platforms, and more particularly but not exclusively, to methods, systems, and computer readable media to provide a distributed database that can support serving a massive-scale virtual word.

### BACKGROUND

Online platforms, such as virtual-experience platforms and online-gaming platforms, can include client devices on which a user interacts with a virtual experience and virtual-experience servers, which manage the state of the virtual experience.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to one aspect of the present disclosure, a computer-implemented method of a virtual-experience coordinator is provided. The computer-implemented method includes determining, by a processor, a plurality of regions associated with a virtual experience. Each of the plurality of regions is associated with a different set of virtual-experience models and virtual-experience scripts. The computer-implemented method includes assigning, by the processor, each of the plurality of regions to a respective virtual-experience server of a plurality of virtual-experience servers. The computer-implemented method includes causing, by the processor, each of the plurality of virtual-experience servers to simulate its assigned region.

In some implementations, determining the plurality of regions includes determining a locality of each virtual-experience model and virtual-experience script in the virtual experience. In some implementations, determining the plurality of regions includes grouping the different sets of virtual experience models and virtual-experience scripts into the plurality of regions based on their respective localities within the virtual experience.

In some implementations, assigning each of the plurality of regions to the respective virtual-experience server of the plurality of virtual-experience servers includes determining, at a first time, a first workload of a first region and a second workload of a second region. In some implementations, assigning each of the plurality of regions to the respective virtual-experience server of the plurality of virtual-experience servers includes determining, at the first time, a first set of workload characteristics of a first virtual-experience server and a second set of workload characteristics of a second virtual-experience server. In some implementations, assigning each of the plurality of regions to the respective virtual-experience server of the plurality of virtual-experience servers includes, in response to the first workload of the first region not exceeding a first threshold value associated with the first set of workload characteristics, assigning, at the first time, the first region to the first virtual-experience server. In some implementations, assigning each of the plurality of regions to the respective virtual-experience server of the plurality of virtual-experience servers includes, in response to the second workload of the second region not exceeding a second threshold value associated with the second set of workload characteristics, assigning, at the first time, the second region to the second virtual-experience server.

In some implementations, assigning each of the plurality of regions to the respective virtual-experience server of the plurality of virtual-experience servers further includes determining, at a second time, a change in one or more of the first workload of the first region or the first set of workload characteristics of the first virtual-experience server causes the first workload to exceed the first threshold value. In some implementations, assigning each of the plurality of regions to the respective virtual-experience server of the plurality of virtual-experience servers further includes, in response to a third workload of a portion of the first region combined with the second workload of the second region not exceeding the second threshold value associated with the second set of workload characteristics, reassigning, at the second time, the portion of the first region to the second virtual-experience server.

In some implementations, the first workload includes one or more of a first computational workload or first latency requirements. In some implementations, the second workload includes one or more of a second computational workload or second latency requirements. In some implementations, the first set of workload characteristics includes one or more of first processing capabilities or first network conditions. In some implementations, the second set of workload characteristics includes one or more of second processing capabilities or second network conditions.

In some implementations, causing each of the plurality of virtual-experience servers to simulate the respective region of the virtual experience that corresponds to its assigned region includes sending, to each of the plurality of virtual-experience servers, information associated with virtual-experience models and virtual-experience scripts of its assigned region.

In some implementations, the computer-implemented method further includes determining, by the processor, a region of the virtual experience in which an avatar associated with a client device will enter. In some implementations, the computer-implemented method further includes determining, by the processor, a virtual-experience server to which the region is assigned. In some implementations, the computer-implemented method further includes assigning, by the processor, the client device to the virtual-experience server.

According to another aspect of the present disclosure, a non-transitory computer-readable medium of a virtual-experience coordinator is provided. The non-transitory computer-readable medium including instructions stored thereon that, when executed by one or more hardware processors, cause the one or more hardware processors to perform operations. The operations include determining a plurality of regions associated with a virtual experience. Each of the plurality of regions is associated with a different set of virtual-experience models and virtual-experience scripts. The operations include assigning each of the plurality of regions to a respective virtual-experience server of a plurality of virtual-experience servers. The operations include causing each of the plurality of virtual-experience servers to simulate its assigned region.

In some implementations, determining the plurality of regions includes determining a locality of each virtual-experience model and virtual-experience script in the virtual experience. In some implementations, determining the plurality of regions includes grouping the different sets of virtual experience models and virtual-experience scripts into the plurality of regions based on their respective localities within the virtual experience.

In some implementations, assigning each of the plurality of regions to the respective virtual-experience server of the plurality of virtual-experience servers includes determining, at a first time, a first workload of a first region and a second workload of a second region. In some implementations, assigning each of the plurality of regions to the respective virtual-experience server of the plurality of virtual-experience servers includes determining, at the first time, a first set of workload characteristics of a first virtual-experience server and a second set of workload characteristics of a second virtual-experience server. In some implementations, assigning each of the plurality of regions to the respective virtual-experience server of the plurality of virtual-experience servers includes, in response to the first workload of the first region not exceeding a first threshold value associated with the first set of workload characteristics, assigning, at the first time, the first region to the first virtual-experience server. In some implementations, assigning each of the plurality of regions to the respective virtual-experience server of the plurality of virtual-experience servers includes, in response to the second workload of the second region not exceeding a second threshold value associated with the second set of workload characteristics, assigning, at the first time, the second region to the second virtual-experience server.

In some implementations, assigning each of the plurality of regions to the respective virtual-experience server of the plurality of virtual-experience servers further includes determining, at a second time, a change in one or more of the first workload of the first region or the first set of workload characteristics of the first virtual-experience server causes the first workload to exceed the first threshold value. In some implementations, assigning each of the plurality of regions to the respective virtual-experience server of the plurality of virtual-experience servers further includes, in response to a third workload of a portion of the first region combined with the second workload of the second region not exceeding the second threshold value associated with the second set of workload characteristics, reassigning, at the second time, the portion of the first region to the second virtual-experience server.

In some implementations, the first workload includes one or more of a first computational workload or first latency requirements. In some implementations, the second workload includes one or more of a second computational workload or second latency requirements. In some implementations, the first set of workload characteristics includes one or more of first processing capabilities or first network conditions. In some implementations, the second set of workload characteristics includes one or more of second processing capabilities or second network conditions.

In some implementations, causing each of the plurality of virtual-experience servers to simulate the respective region of the virtual experience that corresponds to its assigned region includes sending, to each of the plurality of virtual-experience servers, information associated with virtual-experience models and virtual-experience scripts of its assigned region.

In some implementations, the operations further include determining a region of the virtual experience in which an avatar associated with a client device will enter. In some implementations, the operations further include determining a virtual-experience server to which the region is assigned. In some implementations, the operations further include assigning the client device to the virtual-experience server.

According to a further aspect of the present disclosure, a computing device of a virtual-experience coordinator is provided. The computing device includes one or more hardware processors. The computing device may include a non-transitory computer readable medium coupled to the one or more hardware processors, with instructions stored thereon, that when executed by the one or more hardware processors, cause the one or more hardware processors to perform operations. The operations include determining a plurality of regions associated with a virtual experience. Each of the plurality of regions is associated with a different set of virtual-experience models and virtual-experience scripts. The operations include assigning each of the plurality of regions to a respective virtual-experience server of a plurality of virtual-experience servers. The operations include causing each of the plurality of virtual-experience servers to simulate its assigned region.

In some implementations, determining the plurality of regions includes determining a locality of each virtual-experience model and virtual-experience script in the virtual experience. In some implementations, determining the plurality of regions includes grouping the different sets of virtual experience models and virtual-experience scripts into the plurality of regions based on their respective localities within the virtual experience.

In some implementations, assigning each of the plurality of regions to the respective virtual-experience server of the plurality of virtual-experience servers includes determining, at a first time, a first workload of a first region and a second workload of a second region. In some implementations, assigning each of the plurality of regions to the respective virtual-experience server of the plurality of virtual-experience servers includes determining, at the first time, a first set of workload characteristics of a first virtual-experience server and a second set of workload characteristics of a second virtual-experience server. In some implementations, assigning each of the plurality of regions to the respective virtual-experience server of the plurality of virtual-experience servers includes, in response to the first workload of the first region not exceeding a first threshold value associated with the first set of workload characteristics, assigning, at the first time, the first region to the first virtual-experience server. In some implementations, assigning each of the plurality of regions to the respective virtual-experience server of the plurality of virtual-experience servers includes, in response to the second workload of the second region not exceeding a second threshold value associated with the second set of workload characteristics, assigning, at the first time, the second region to the second virtual-experience server.

In some implementations, assigning each of the plurality of regions to the respective virtual-experience server of the plurality of virtual-experience servers further includes determining, at a second time, a change in one or more of the first workload of the first region or the first set of workload characteristics of the first virtual-experience server causes the first workload to exceed the first threshold value. In some implementations, assigning each of the plurality of regions to the respective virtual-experience server of the plurality of virtual-experience servers further includes, in response to a third workload of a portion of the first region combined with the second workload of the second region not exceeding the second threshold value associated with the second set of workload characteristics, reassigning, at the second time, the portion of the first region to the second virtual-experience server.

In some implementations, the first workload includes one or more of a first computational workload or first latency requirements. In some implementations, the second workload includes one or more of a second computational workload or second latency requirements. In some implementations, the first set of workload characteristics includes one or more of first processing capabilities or first network conditions. In some implementations, the second set of workload characteristics includes one or more of second processing capabilities or second network conditions.

In some implementations, causing each of the plurality of virtual-experience servers to simulate the respective region of the virtual experience that corresponds to its assigned region includes sending, to each of the plurality of virtual-experience servers, information associated with virtual-experience models and virtual-experience scripts of its assigned region.

In some implementations, the operations further include determining a region of the virtual experience in which an avatar associated with a client device will enter. In some implementations, the operations further include determining a virtual-experience server to which the region is assigned. In some implementations, the operations further include assigning the client device to the virtual-experience server.

According to still another aspect of the present disclosure, a computer-implemented method of a virtual-experience node is provided. The computer-implemented method includes obtaining, by a processor, an initial version of a set of tables associated with a region of a virtual experience. The region is associated with a set of virtual-experience models and virtual-experience scripts. The initial version of the set of tables is associated with an initial frame. Each table in the set of tables includes a plurality of rows. Each of the plurality of rows corresponds to a portion of the region or a boundary portion that extends into an adjacent region of the virtual experience. Each row contains information associated with a virtual object located in a corresponding portion of the region. Each row in the initial version of the set of tables includes a first authority label and a first change marker. The computer-implemented method includes simulating, by the processor, the initial frame of the region of the virtual experience based at least in part on the initial version of the set of tables. The computer-implemented method includes generating, by the processor, an updated version of the set of tables associated with the region based on one or more first changes to a first virtual object in the region of the virtual experience. The updated version of the set of tables is associated with a subsequent frame. Each row in the updated version of the set of tables includes a second authority label and a second change marker. The computer-implemented method includes simulating, by the processor, the subsequent frame of the region of the virtual experience based at least in part on the updated version of the set of tables.

In some implementations, the computer-implemented method includes maintaining, by the processor, the initial version and the updated version of the set of tables for a predetermined number of frames. In some implementations, the computer-implemented method includes deleting, by the processor, the initial version and the updated version of tables after the predetermined number of frames is reached.

In some implementations, obtaining the initial version of a set of tables includes generating a first row associated with the first virtual object, the first virtual object being an avatar associated with the virtual-experience node. In some implementations, obtaining the initial version of a set of tables includes assigning the first row associated with the first virtual object a definitive authority label and an added change marker. In some implementations, obtaining the initial version of a set of tables includes generating a second row associated with a second virtual object, the second virtual object being a non-avatar virtual object or another avatar associated with a different virtual experience node. In some implementations, obtaining the initial version of a set of tables includes assigning the second row associated with the second virtual object with a speculative authority label and the added change marker.

In some implementations, generating the updated version of the set of tables includes updating the first row associated with the first virtual object based on the one or more first changes. In some implementations, generating the updated version of the set of tables includes assigning the first row associated with the first virtual object the definitive authority label and a changed-new change marker. In some implementations, generating the updated version of the set of tables includes maintaining the second row associated with the second virtual object that is unchanged. In some implementations, generating the updated version of the set of tables includes assigning the second row associated with the second virtual object with the speculative authority label and an unchanged change marker.

In some implementations, the computer-implemented method further includes sending, by the processor, a key and a delta value associated with the first row updated based on the one or more first changes to another virtual-experience node.

In some implementations, the computer-implemented method further includes receiving, by the processor, a key and a delta value from another virtual-experience node. In some implementations, the key and the delta value indicate one or more second changes to the second virtual object occurred in the subsequent frame. In some implementations, the key and the delta value include the definitive authority label. In some implementations, the computer-implemented method further includes identifying, by the processor, the second row in the updated version of the set of tables based on the key. In some implementations, the computer-implemented method further includes determining, by the processor, to update the second row in the updated version of the set of tables based on the speculative authority label. In some implementations, the computer-implemented method further includes generating, by the processor, another second row in the updated version of the set of tables based on the delta value. In some implementations, the computer-implemented method further includes assigning, by the processor, the another second row in the updated version of the set of tables with the speculative authority label and a changed-new change marker. In some implementations, the computer-implemented method further includes reassigning, by the processor, the second row associated with the second virtual object with the speculative authority label and a changed-old change marker. In some implementations, the computer-implemented method further includes re-simulating, by the processor, the second virtual object in at least one frame based on the delta value.

In some implementations, receiving, by the processor, a key and a delta value associated with a third virtual object, wherein generating the updated version of the set of tables includes determining, by the processor, the updated version of the set of tables does not include a third row associated with the third virtual object based on the key. In some implementations, receiving, by the processor, a key and a delta value associated with a third virtual object, wherein generating the updated version of the set of tables includes generating, by the processor, the third row associated with the virtual object based on the delta value. In some implementations, receiving, by the processor, a key and a delta value associated with a third virtual object, wherein generating the updated version of the set of tables includes assigning, by the processor, the third row associated with the third virtual object the speculative authority label and the added change marker.

In some implementations, the computer-implemented method further includes receiving, by the processor, a key and a delta value associated with the second virtual object that indicates the second virtual object is no longer located in the region associated with the virtual-experience node. In some implementations, generating the updated version of the set of tables includes generating, by the processor, another second row associated with the second virtual object based on the delta value. In some implementations, generating the updated version of the set of tables includes assigning, by the processor, the another second row associated with the second virtual object a speculative authority label and a deleted change marker.

In some implementations, the computer-implemented method further includes determining, by a processor, a new region of the virtual experience is visible to an avatar associated with the virtual-experience node. In some implementations, the computer-implemented method further includes sending, by the processor, a request to a coordinator node for information associated with a different virtual-experience node that manages the new region. In some implementations, the computer-implemented method further includes receiving, by the processor, the information associated with the different virtual-experience node that manages the new region from the coordinator node. In some implementations, the computer-implemented method further includes requesting, by the processor, a set of replicated tables associated with the new region of the virtual experience from the different virtual-experience node. In some implementations, the computer-implemented method further includes obtaining, by the processor, the set of replicated tables associated with the new region from the different virtual-experience node.

In some implementations, the computer-implemented method further includes sending, by the processor, one or more of the initial version of the set of tables or the updated version of the set of tables to another virtual-experience node.

In some implementations, the computer-implemented method further includes receiving, by the processor, a request for the one or more of the initial version of the set of tables or the updated version of the set of tables from the another virtual-experience node.

In some implementations, sending the one or more of the initial version of the set of tables or the updated version of the set of tables to the another virtual-experience node occurs automatically at predetermined intervals.

In some implementations, the computer-implemented method further includes assigning, by the processor, the initial version set of tables and the updated set of tables an authoritative marker. In some implementations, the computer-implemented method further includes obtaining, by the processor, a set of replicated tables associated with a different region of the virtual experience managed by another virtual-experience node. In some implementations, the computer-implemented method further includes assigning, by the processor, the set of replicated tables a replicated marker.

In some implementations, the computer-implemented method further includes maintaining, by the processor, a global directory that maps virtual objects to their respective regions in the virtual experience. In some implementations, the computer-implemented method further includes determining, by the processor, a script accesses a second virtual object located in a region associated with another virtual-experience node. In some implementations, the computer-implemented method further includes sending, by the processor, a read request associated with the second virtual object to the another virtual-experience node. In some implementations, the computer-implemented method further includes receiving, by the processor, a read response including information associated with the second virtual object from the another virtual-experience node. In some implementations, the computer-implemented method further includes simulating, by the processor, another frame based on the information associated with the second virtual object from the read response.

In some implementations, the virtual-experience node includes a virtual-experience server or a client device.

According to another aspect of the present disclosure, a non-transitory computer-readable medium of a virtual-experience server is provided. The non-transitory computer-readable medium including instructions stored thereon that, when executed by one or more hardware processors, cause the one or more hardware processors to perform operations. The operations include obtaining, by a processor, an initial version of a set of tables associated with a region of a virtual experience. The region is associated with a set of virtual-experience models and virtual-experience scripts. The initial version of the set of tables is associated with an initial frame. Each table in the set of tables includes a plurality of rows. Each of the plurality of rows corresponds to a portion of the region or a boundary portion that extends into an adjacent region of the virtual experience. Each row contains information associated with a virtual object located in a corresponding portion of the region. Each row in the initial version of the set of tables includes a first authority label and a first change marker. The operations include simulating, by the processor, the initial frame of the region of the virtual experience based at least in part on the initial version of the set of tables. The operations include generating, by the processor, an updated version of the set of tables associated with the region based on one or more first changes to a first virtual object in the region of the virtual experience. The updated version of the set of tables is associated with a subsequent frame. Each row in the updated version of the set of tables includes a second authority label and a second change marker. The operations include simulating, by the processor, the subsequent frame of the region of the virtual experience based at least in part on the updated version of the set of tables.

In some implementations, the operations include maintaining, by the processor, the initial version and the updated version of the set of tables for a predetermined number of frames. In some implementations, the operations include deleting, by the processor, the initial version and the updated version of tables after the predetermined number of frames is reached.

In some implementations, obtaining the initial version of a set of tables includes generating a first row associated with the first virtual object, the first virtual object being an avatar associated with the virtual-experience node. In some implementations, obtaining the initial version of a set of tables includes assigning the first row associated with the first virtual object a definitive authority label and an added change marker. In some implementations, obtaining the initial version of a set of tables includes generating a second row associated with a second virtual object, the second virtual object being a non-avatar virtual object or another avatar associated with a different virtual experience node. In some implementations, obtaining the initial version of a set of tables includes assigning the second row associated with the second virtual object with a speculative authority label and the added change marker.

In some implementations, generating the updated version of the set of tables includes updating the first row associated with the first virtual object based on the one or more first changes. In some implementations, generating the updated version of the set of tables includes assigning the first row associated with the first virtual object the definitive authority label and a changed-new change marker. In some implementations, generating the updated version of the set of tables includes maintaining the second row associated with the second virtual object that is unchanged. In some implementations, generating the updated version of the set of tables includes assigning the second row associated with the second virtual object with the speculative authority label and an unchanged change marker.

In some implementations, the operations further include sending, by the processor, a key and a delta value associated with the first row updated based on the one or more first changes to another virtual-experience node.

In some implementations, the operations further include receiving, by the processor, a key and a delta value from another virtual-experience node. In some implementations, the key and the delta value indicate one or more second changes to the second virtual object occurred in the subsequent frame. In some implementations, the key and the delta value include the definitive authority label. In some implementations, the operations further include identifying, by the processor, the second row in the updated version of the set of tables based on the key. In some implementations, the operations further include determining, by the processor, to update the second row in the updated version of the set of tables based on the speculative authority label. In some implementations, the operations further include generating, by the processor, another second row in the updated version of the set of tables based on the delta value. In some implementations, the operations further include assigning, by the processor, the another second row in the updated version of the set of tables with the speculative authority label and a changed-new change marker. In some implementations, the operations further include reassigning, by the processor, the second row associated with the second virtual object with the speculative authority label and a changed-old change marker. In some implementations, the operations further include re-simulating, by the processor, the second virtual object in at least one frame based on the delta value.

In some implementations, receiving, by the processor, a key and a delta value associated with a third virtual object, wherein generating the updated version of the set of tables includes determining, by the processor, the updated version of the set of tables does not include a third row associated with the third virtual object based on the key. In some implementations, receiving, by the processor, a key and a delta value associated with a third virtual object, wherein generating the updated version of the set of tables includes generating, by the processor, the third row associated with the virtual object based on the delta value. In some implementations, receiving, by the processor, a key and a delta value associated with a third virtual object, wherein generating the updated version of the set of tables includes assigning, by the processor, the third row associated with the third virtual object the speculative authority label and the added change marker.

In some implementations, the operations further include receiving, by the processor, a key and a delta value associated with the second virtual object that indicates the second virtual object is no longer located in the region associated with the virtual-experience node. In some implementations, generating the updated version of the set of tables includes generating, by the processor, another second row associated with the second virtual object based on the delta value. In some implementations, generating the updated version of the set of tables includes assigning, by the processor, the another second row associated with the second virtual object a speculative authority label and a deleted change marker.

In some implementations, the operations further include determining, by a processor, a new region of the virtual experience is visible to an avatar associated with the virtual-experience node. In some implementations, the operations further include sending, by the processor, a request to a coordinator node for information associated with a different virtual-experience node that manages the new region. In some implementations, the operations further include receiving, by the processor, the information associated with the different virtual-experience node that manages the new region from the coordinator node. In some implementations, the operations further include requesting, by the processor, a set of replicated tables associated with the new region of the virtual experience from the different virtual-experience node. In some implementations, the operations further include obtaining, by the processor, the set of replicated tables associated with the new region from the different virtual-experience node.

In some implementations, the operations further include sending, by the processor, one or more of the initial version of the set of tables or the updated version of the set of tables to another virtual-experience node.

In some implementations, the operations further include receiving, by the processor, a request for the one or more of the initial version of the set of tables or the updated version of the set of tables from the another virtual-experience node.

In some implementations, sending the one or more of the initial version of the set of tables or the updated version of the set of tables to the another virtual-experience node occurs automatically at predetermined intervals.

In some implementations, the operations further include assigning, by the processor, the initial version set of tables and the updated set of tables an authoritative marker. In some implementations, the operations further include obtaining, by the processor, a set of replicated tables associated with a different region of the virtual experience managed by another virtual-experience node. In some implementations, the operations further include assigning, by the processor, the set of replicated tables a replicated marker.

In some implementations, the operations further include maintaining, by the processor, a global directory that maps virtual objects to their respective regions in the virtual experience. In some implementations, the operations further include determining, by the processor, a script accesses a second virtual object located in a region associated with another virtual-experience node. In some implementations, the operations further include sending, by the processor, a read request associated with the second virtual object to the another virtual-experience node. In some implementations, the operations further include receiving, by the processor, a read response including information associated with the second virtual object from the another virtual-experience node. In some implementations, the operations further include simulating, by the processor, another frame based on the information associated with the second virtual object from the read response.

In some implementations, the virtual-experience node includes a virtual-experience server or a client device.

According to a further aspect of the present disclosure, a computing device of a virtual-experience coordinator is provided. The computing device includes one or more hardware processors. The computing device may include a non-transitory computer readable medium coupled to the one or more hardware processors, with instructions stored thereon, that when executed by the one or more hardware processors, cause the one or more hardware processors to perform operations. The operations include obtaining, by a processor, an initial version of a set of tables associated with a region of a virtual experience. The region is associated with a set of virtual-experience models and virtual-experience scripts. The initial version of the set of tables is associated with an initial frame. Each table in the set of tables includes a plurality of rows. Each of the plurality of rows corresponds to a portion of the region or a boundary portion that extends into an adjacent region of the virtual experience. Each row contains information associated with a virtual object located in a corresponding portion of the region. Each row in the initial version of the set of tables includes a first authority label and a first change marker. The operations include simulating, by the processor, the initial frame of the region of the virtual experience based at least in part on the initial version of the set of tables. The operations include generating, by the processor, an updated version of the set of tables associated with the region based on one or more first changes to a first virtual object in the region of the virtual experience. The updated version of the set of tables is associated with a subsequent frame. Each row in the updated version of the set of tables includes a second authority label and a second change marker. The operations include simulating, by the processor, the subsequent frame of the region of the virtual experience based at least in part on the updated version of the set of tables.

In some implementations, the operations include maintaining, by the processor, the initial version and the updated version of the set of tables for a predetermined number of frames. In some implementations, the operations include deleting, by the processor, the initial version and the updated version of tables after the predetermined number of frames is reached.

In some implementations, obtaining the initial version of a set of tables includes generating a first row associated with the first virtual object, the first virtual object being an avatar associated with the virtual-experience node. In some implementations, obtaining the initial version of a set of tables includes assigning the first row associated with the first virtual object a definitive authority label and an added change marker. In some implementations, obtaining the initial version of a set of tables includes generating a second row associated with a second virtual object, the second virtual object being a non-avatar virtual object or another avatar associated with a different virtual experience node. In some implementations, obtaining the initial version of a set of tables includes assigning the second row associated with the second virtual object with a speculative authority label and the added change marker.

In some implementations, generating the updated version of the set of tables includes updating the first row associated with the first virtual object based on the one or more first changes. In some implementations, generating the updated version of the set of tables includes assigning the first row associated with the first virtual object the definitive authority label and a changed-new change marker. In some implementations, generating the updated version of the set of tables includes maintaining the second row associated with the second virtual object that is unchanged. In some implementations, generating the updated version of the set of tables includes assigning the second row associated with the second virtual object with the speculative authority label and an unchanged change marker.

In some implementations, the operations further include sending, by the processor, a key and a delta value associated with the first row updated based on the one or more first changes to another virtual-experience node.

In some implementations, the operations further include receiving, by the processor, a key and a delta value from another virtual-experience node. In some implementations, the key and the delta value indicate one or more second changes to the second virtual object occurred in the subsequent frame. In some implementations, the key and the delta value include the definitive authority label. In some implementations, the operations further include identifying, by the processor, the second row in the updated version of the set of tables based on the key. In some implementations, the operations further include determining, by the processor, to update the second row in the updated version of the set of tables based on the speculative authority label. In some implementations, the operations further include generating, by the processor, another second row in the updated version of the set of tables based on the delta value. In some implementations, the operations further include assigning, by the processor, the another second row in the updated version of the set of tables with the speculative authority label and a changed-new change marker. In some implementations, the operations further include reassigning, by the processor, the second row associated with the second virtual object with the speculative authority label and a changed-old change marker. In some implementations, the operations further include re-simulating, by the processor, the second virtual object in at least one frame based on the delta value.

In some implementations, receiving, by the processor, a key and a delta value associated with a third virtual object, wherein generating the updated version of the set of tables includes determining, by the processor, the updated version of the set of tables does not include a third row associated with the third virtual object based on the key. In some implementations, receiving, by the processor, a key and a delta value associated with a third virtual object, wherein generating the updated version of the set of tables includes generating, by the processor, the third row associated with the virtual object based on the delta value. In some implementations, receiving, by the processor, a key and a delta value associated with a third virtual object, wherein generating the updated version of the set of tables includes assigning, by the processor, the third row associated with the third virtual object the speculative authority label and the added change marker.

In some implementations, the operations further include receiving, by the processor, a key and a delta value associated with the second virtual object that indicates the second virtual object is no longer located in the region associated with the virtual-experience node. In some implementations, generating the updated version of the set of tables includes generating, by the processor, another second row associated with the second virtual object based on the delta value. In some implementations, generating the updated version of the set of tables includes assigning, by the processor, the another second row associated with the second virtual object a speculative authority label and a deleted change marker.

In some implementations, the operations further include determining, by a processor, a new region of the virtual experience is visible to an avatar associated with the virtual-experience node. In some implementations, the operations further include sending, by the processor, a request to a coordinator node for information associated with a different virtual-experience node that manages the new region. In some implementations, the operations further include receiving, by the processor, the information associated with the different virtual-experience node that manages the new region from the coordinator node. In some implementations, the operations further include requesting, by the processor, a set of replicated tables associated with the new region of the virtual experience from the different virtual-experience node. In some implementations, the operations further include obtaining, by the processor, the set of replicated tables associated with the new region from the different virtual-experience node.

In some implementations, the operations further include sending, by the processor, one or more of the initial version of the set of tables or the updated version of the set of tables to another virtual-experience node.

In some implementations, the operations further include receiving, by the processor, a request for the one or more of the initial version of the set of tables or the updated version of the set of tables from the another virtual-experience node.

In some implementations, sending the one or more of the initial version of the set of tables or the updated version of the set of tables to the another virtual-experience node occurs automatically at predetermined intervals.

In some implementations, the operations further include assigning, by the processor, the initial version set of tables and the updated set of tables an authoritative marker. In some implementations, the operations further include obtaining, by the processor, a set of replicated tables associated with a different region of the virtual experience managed by another virtual-experience node. In some implementations, the operations further include assigning, by the processor, the set of replicated tables a replicated marker.

In some implementations, the operations further include maintaining, by the processor, a global directory that maps virtual objects to their respective regions in the virtual experience. In some implementations, the operations further include determining, by the processor, a script accesses a second virtual object located in a region associated with another virtual-experience node. In some implementations, the operations further include sending, by the processor, a read request associated with the second virtual object to the another virtual-experience node. In some implementations, the operations further include receiving, by the processor, a read response including information associated with the second virtual object from the another virtual-experience node. In some implementations, the operations further include simulating, by the processor, another frame based on the information associated with the second virtual object from the read response.

In some implementations, the virtual-experience node includes a virtual-experience server or a client device.

### BRIEF DESCRIPTION OF DRAWINGS

FIG. 1 is a diagram of an example network environment, in accordance with some implementations.

FIG. 2 is a diagram of an example virtual experience with different regions, in accordance with some implementations.

FIG. 3 is a diagram of an example table used for simulating a region of a virtual experience by a node, in accordance with some implementations.

FIG. 4 is a diagram of example change markers for a table maintained by a node, in accordance with some implementations.

FIG. 5 is a diagram of example tables and queries for simulating a region of a virtual world by a node, in accordance with some implementations.

FIG. 6 is a diagram of an example trigger for updating a table based on a broad-phase query, in accordance with some implementations.

FIG. 7 is a graphical illustration of scalability of a database with the number of supported regions plotted against the number of virtual-experience servers, in accordance with some implementations.

FIG. 8 is a graphical illustration of consistency of data movement per server, in accordance with some implementations.

FIG. 9 is a graphical illustration of memory consumption verse the number of regions managed by a virtual-experience server, in accordance with some implementations.

FIG. 10 is a graphical illustration of an amount of replication traffic versus the number of regions simulated by a client device, in accordance with some implementations.

FIG. 11 is a flowchart of a method of managing a simulation of a virtual world by a coordinator node, in accordance with some implementations.

FIGS. 12A-12F are a flowchart of a method of simulating a region of a virtual world by a node, in accordance with some implementations.

FIG. 13 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

Various embodiments are described herein in the context of simulating a massive-scale virtual world. Some implementations of the techniques described herein may be applied to various types of three-dimensional (3D) environments, such as a virtual reality (VR) conference, a 3D session (e.g., an online lecture or other type of presentation involving 3D avatars), a virtual concert, an augmented reality (AR) session, or in other types of 3D environments that may include one or more users that are represented in the 3D environment by one or more 3D avatars.

Some virtual-world platforms provide metaverses, combining user-generated content with massive, persistent, and immersive worlds. However, none or few of these virtual-world platforms can effectively/efficiently achieve a canonical metaverse with a single, coherent world in which a thousand or more people interact. Instead, these virtual-world platforms provide a large set of much smaller worlds (instances), with dozens or perhaps a few hundred users per instance.

At first glance, supporting massive-scale virtual worlds may seem to be about 3D rendering. However, graphics, which are local on a player's device, typically process the small part of the virtual world that is within a player's field of view. Thus, a challenge is instead the simulation aspect of the massive-scale virtual world that should be consistent and global across the client devices of the users that participate in the world. A simulation of the virtual world may be run based on physics and script computations.

For instance, the physics computation ensures that when a player drops a ball, the ball falls to the ground and then bounces off it. The script computation ensures that when a player flips a light switch, the light will turn on or off.

Generally, any object or script can influence any other. This all-to-all web of potential interactions and the state synchronization behind it is what makes scalability difficult to achieve. The state of a virtual world is maintained by a virtual-experience server in key-data rows, but also relationally through a semantic tree data model, spatially through 3D positions, and temporally through the real-time synchronization of simulation across devices to present a consistent virtual reality.

Large-scale virtual worlds first emerged in the context of multiplayer games, but they have since evolved into a cloud service platforms that provide general-purpose virtual worlds that are used by content developers to implement specific experiences, such as games or virtual offices.

However, these virtual-world platforms suffer from scalability limitations. Thus, although some virtual-world platform providers have hundreds of millions of users, this large cohort of users is spread across millions of small worlds with perhaps a few dozen users, which enables computations to run on a single virtual-experience server.

Scaling general-purpose virtual worlds has been recognized as a challenge, and there have been several attempts to address it. An approach is to find a way to seamlessly spread worlds across multiple servers. This is difficult for at least three reasons.

First, there are many actual and potential data dependencies. So, if the workload is not partitioned properly, the network quickly becomes a bottleneck. Second, the workload is highly sensitive to timing. So, even if data spends just a few milliseconds in transit between machines, the data can arrive too late and cause artifacts. Third, network latency is not well tolerated (e.g., at a simulation rate of 60 frames per second (fps), the simulation of the virtual world may be updated every 16 milliseconds). So far, few effective/efficient solutions have emerged for providing a massive-scale virtual world in which a thousand or more users interact.

To address these and other challenges, the present disclosure provides technique(s) that support virtual-world platform workloads for virtual worlds of any size. These technique(s) are based on at least three aspects. First, virtual-world workloads may be inherently spatial: most interactions occur between virtual objects that are proximate to each other in a 3D virtual space. This creates locality that can be exploited for efficient partitioning. Second, a form of temporal consistency can be used to properly “stitch together” events from different nodes (e.g., client device(s), virtual-experience server(s), database(s), etc.), so the simulation of these events appears seamless, despite network delays. Third, speculation can be used to keep game play (or other interaction) moving forward on a client device even when game-play data (or other data) has not yet arrived. This may be implemented using a form of incremental-view maintenance to efficiently update the virtual world at the client device once the data does arrive.

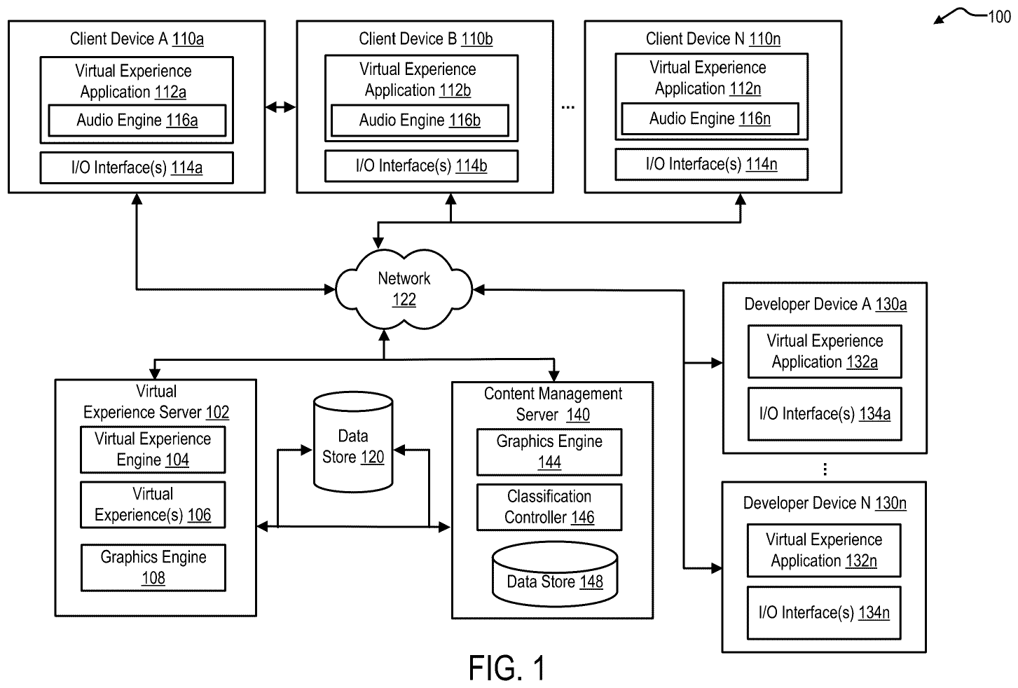

Consequently, the technique(s) described below with reference to FIGS. 1-13 support virtual worlds that scale linearly with the number of available virtual-experience servers. This is a step forward, considering the single-server worlds on current platforms and the previous uncertainty as to whether general-purpose worlds could scale at all.

### Example Environment

FIG. 1 is a diagram of an example network environment that supports virtual-world platform workloads for virtual worlds of any size, in accordance with some implementations. FIG. 1 and other figures use like reference numerals to identify like elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

A system architecture 100 (also referred to as “system” herein) includes online virtual experience server 102, data store 120, client devices 110a, 110b, and 110n (generally referred to as “client device(s) 110” herein), developer devices 130a and 130n (generally referred to as “developer device(s) 130” herein), and content management server 140 coupled via network 122. In some implementations, client devices 110 and developer device(s) 130 may refer to the same or same type of device.

Online virtual experience server 102 can include a virtual experience engine 104, one or more virtual experience(s) 106, and graphics engine 108. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc. The input/output devices can also include accessory devices that are connected to the client device by a cable (wired) or that are wirelessly connected.

Content management server 140 can include a graphics engine 144, and a classification controller 146. In some implementations, the content management server may include a plurality of servers. In some implementations, the plurality of servers may be arranged in a hierarchy (e.g., based on respective prioritization values assigned to content sources).

Graphics engine 144 may be utilized for the rendering of one or more objects (e.g., 3D objects associated with the virtual environment). Classification controller 146 may be utilized to classify assets such as 3D objects and for the detection of inauthentic digital assets, etc. Data store 148 may be utilized to store a search index, model information, etc.

Developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, etc. or a combination thereof.

In some implementations, the data store 120 may be a tangible (e.g., hardware) non-transitory computer readable memory (e.g., random access memory), a cache, a drive (e.g., a hard drive), a flash drive, a database system, a cloud storage system, or another type of component or device capable of storing data. The data store 120 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, a distributed computing system, a cloud computing system, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), text chat (e.g., synchronous and/or asynchronous text-based communication), and/or multi-user mesh modeling. In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be an online gaming server. For example, the virtual experience server may provide single-player or multiplayer games to a community of users that may access or interact with games using client devices 110 via network 122. In some implementations, games (also referred to as “video game,” “online game,” or “virtual game” herein) may be two-dimensional (2D) games, three-dimensional (3D) games (e.g., 3D user-generated games), virtual reality (VR) games, or augmented reality (AR) games, for example. In some implementations, users may participate in gameplay with other users. In some implementations, a game may be played in real-time with other users of the game.

In some implementations, gameplay may refer to the interaction of one or more players using client devices (e.g., 110) within a game (e.g., game that is part of virtual experience 106) or the presentation of the interaction on a display or other output device (e.g., 114) of a client device 110.

In some implementations, a virtual experience 106 can include an electronic file that can be executed or loaded using software, firmware or hardware configured to present the game content (e.g., digital media item) to an entity. In some implementations, a virtual experience application 112 may be executed and a virtual experience 106 executed in connection with a virtual experience engine 104. In some implementations, a virtual experience (e.g., a game) 106 may have a common set of rules or common goal, and the environment of a virtual experience 106 shares the common set of rules or common goal. In some implementations, different games may have different rules or goals from one another.

In some implementations, virtual experience(s) may have one or more environments (also referred to as “gaming environments” or “virtual environments” herein) where multiple environments may be linked. An example of an environment may be a three-dimensional (3D) environment. The one or more environments of a virtual experience application 112 may be collectively referred to a “world” or “gaming world” or “virtual world” or “universe” herein. An example of a world may be a 3D world of a virtual experience 106. For example, a user may build a virtual environment that is linked to another virtual environment created by another user. A character of the virtual game may cross the virtual border to enter the adjacent virtual environment.

It may be noted that 3D environments or 3D worlds use graphics that use a three-dimensional representation of geometric data representative of game content (or at least present game content to appear as 3D content whether or not 3D representation of geometric data is used). 2D environments or 2D worlds use graphics that use two-dimensional representation of geometric data representative of game content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “game objects” or “virtual game item(s)” herein) of virtual experiences 106. For example, in generating user-generated virtual items, users may create characters, decoration for the characters, one or more virtual environments for an interactive game, or build structures used in a game. In some implementations, users may buy, sell, or trade virtual game objects, such as in-platform currency (e.g., virtual currency), with other users of the online virtual experience server 102. In some implementations, online virtual experience server 102 may transmit game content to virtual experience applications (e.g., 112). In some implementations, game content (also referred to as “content” herein) may refer to any data or software instructions (e.g., game objects, game, user information, video, images, commands, media item, etc.) associated with online virtual experience server 102 or virtual experience applications. In some implementations, game objects (e.g., also referred to as “item(s)” or “objects” or “virtual objects” or “virtual game item(s)” herein) may refer to objects that are used, created, shared or otherwise depicted in virtual experiences 106 of the online virtual experience server 102 or virtual experience applications 112 of the client devices 110. For example, game objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration, rather than limitation. In some implementations, online virtual experience server 102 may host one or more media items that can include communication messages from one user to one or more other users. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual application 106 may be associated with a particular user or a particular group of users (e.g., a private game), or made widely available to users with access to the online virtual experience server 102 (e.g., a public game). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the game (e.g., rendering commands, collision commands, physics commands, etc.) In some implementations, virtual experience applications 112 of client devices 110 may work independently, in collaboration with virtual experience engine 104 of online virtual experience server 102, or a combination of both.

In some implementations, both the online virtual experience server 102 and client devices 110 may execute a virtual experience engine and a virtual experience application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual application 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual application objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on gameplay conditions. For example, if the number of users participating in gameplay of a particular virtual application 106 exceeds a threshold number, the online virtual experience server 102 may perform one or more virtual experience engine functions that were previously performed by the client devices 110.

For example, users may be playing a virtual application 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send gameplay instructions (e.g., position and velocity information of the characters participating in the group gameplay or commands, such as rendering commands, collision commands, etc.) to the client devices 110 based on control instructions. For instance, the online virtual experience server 102 may perform one or more logical operations (e.g., using virtual experience engine 104) on the control instructions to generate gameplay instruction(s) for the client devices 110. In other instances, online virtual experience server 102 may pass one or more or the control instructions from one client device 110 to other client devices (e.g., from client device 110a to client device 110b) participating in the virtual application 106. The client devices 110 may use the gameplay instructions and render the gameplay for presentation on the displays of client devices 110.

In some implementations, the control instructions may refer to instructions that are indicative of in-game actions of a user's character. For example, control instructions may include user input to control the in-game action, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates gameplay instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, gameplay instructions may refer to instructions that allow a client device 110 to render gameplay of a game, such as a multiplayer game. The gameplay instructions may include one or more of user input (e.g., control instructions), character position and velocity information, or commands (e.g., physics commands, rendering commands, collision commands, etc.).

In some implementations, the online virtual experience server 102 may store characters created by users in the data store 120. In some implementations, the online virtual experience server 102 maintains a character catalog and game catalog that may be presented to users. In some implementations, the game catalog includes images of virtual experiences stored on the online virtual experience server 102. In addition, a user may select a character (e.g., a character created by the user or other user) from the character catalog to participate in the chosen game. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the virtual experience platform may support three-dimensional (3D) objects that are represented by a 3D model and includes a surface representation used to draw the character or object (also known as a skin or mesh) and a hierarchical set of interconnected bones (also known as a skeleton or rig). The rig may be utilized to animate the object and to simulate motion of the object. The 3D model may be represented as a data structure, and one or more parameters of the data structure may be modified to change various properties of the character, e.g., dimensions (height, width, girth, etc.); shape; movement style; number/type of parts; proportion, etc.

In some implementations, the 3D model may include a 3D mesh. The 3D mesh may define a three-dimensional structure of the unauthenticated virtual 3D object. In some implementations, the 3D mesh may also define one or more surfaces of the 3D object. In some implementations, the 3D object may be a virtual avatar, e.g., a virtual character such as a humanoid character, an animal-character, a robot-character, etc.

In some implementations, the mesh may be received (imported) in a FBX file format. The mesh file includes data that provides dimensional data about polygons that comprise the virtual 3D object and UV map data that describes how to attach portions of texture to various polygons that comprise the 3D object. In some implementations, the 3D object may correspond to an accessory, e.g., a hat, a weapon, a piece of clothing, etc. worn by a virtual avatar or otherwise depicted with reference to a virtual avatar.

In some implementations, a platform may enable users to submit (upload) candidate 3D objects for utilization on the platform. A virtual experience development environment (developer tool) may be provided by the platform, in accordance with some implementations. The virtual experience development environment may provide a user interface that enables a developer user to design and/or create virtual experiences, e.g. games. The virtual experience development environment may be a client-based tool (e.g., downloaded and installed on a client device, and operated from the client device), a server-based tool (e.g., installed and executed at a server that is remote from the client device, and accessed and operated by the client device), or a combination of both client-based and service-based elements.

The virtual experience development environment may be operated by a developer of a virtual experience, e.g., a game developer or any other person who seeks to create a virtual experience that may be published by an online virtual experience platform and utilized by others. The user interface of the virtual experience development environment may be rendered on a display screen of a client device, e.g., such as a developer device 130 described with reference to FIG. 1, so as to enable the creator/developer to interact with the development environment using actions such as typing, highlighting, selecting, drag and drop, clicking, and so forth via a mouse, keyboard, or other input device configured to communicate with the user interface. The user interface may include a menu bar, a tool bar, a workspace pane, and a plurality of secondary panes. Depending on the particular implementation, the user interface may include alternative or additional elements, arrangements, operational features, etc. of the virtual experience development environment than what is shown and described herein.

A developer user (creator) may utilize the virtual experience development environment to create virtual experiences. As part of the development process, the developer/creator may upload various types of digital content such as object files (meshes), image files, audio files, short videos, etc., to enhance the virtual experience.

In implementations where the 3D object is an accessory, data indicative of use of the object in a virtual experience may also be received. For example, a “shoe” object may include annotations indicating that the object can be depicted as being worn on the feet of a virtual humanoid character, while a “shirt” object may include annotations that it may be depicted as being worn on the torso of a virtual humanoid character.

In some implementations, the 3D model may further include texture information associated with the 3D object. For example, texture information may indicate color and/or pattern of an outer surface of the 3D object. The texture information may enable varying degrees of transparency, reflectiveness, degrees of diffusiveness, material properties, and refractory behavior of the textures and meshes associated with the 3D object. Examples of textures include plastic, cloth, grass, a pane of light blue glass, ice, water, concrete, brick, carpet, wood, etc.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “client device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

In some implementations, the virtual experience application may include an audio engine 116 that is installed on the client device, and which enables the playback of sounds on the client device. In some implementations, audio engine 116 may act cooperatively with audio engine 144 that is installed on the sound server.

According to aspects of the disclosure, the virtual experience application may be an online virtual experience server application for users to build, create, edit, and/or upload content to the online virtual experience server 102 as well as interact with online virtual experience server 102 (e.g., participate in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a virtual experience program) that is installed and executes local to developer device 130 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

According to aspects of the disclosure, the virtual experience application 132 may be an online virtual experience server application for users to build, create, edit, and/or upload content to the online virtual experience server 102 as well as interact with online virtual experience server 102 (e.g., provide and/or play virtual experiences 106 hosted by online virtual experience server 102). As such, the virtual experience application may be provided to the client device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual applications 106 developed, hosted, or provided by a virtual experience application developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience application developer may obtain access to virtual experience application objects, such as in-platform currency (e.g., virtual currency), avatars, special powers, accessories, which are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through appropriate application programming interfaces (APIs) and thus is not limited to use in websites.

In some implementations, online virtual experience server 102 may include a graphics engine 108. In some implementations, the graphics engine 108 may be a system, application, or module that permits the online virtual experience server 102 to provide graphics and animation capability. In some implementations, the graphics engine 108, and/or content management server 140 may perform one or more of the operations described below.

### Example Virtual Experience

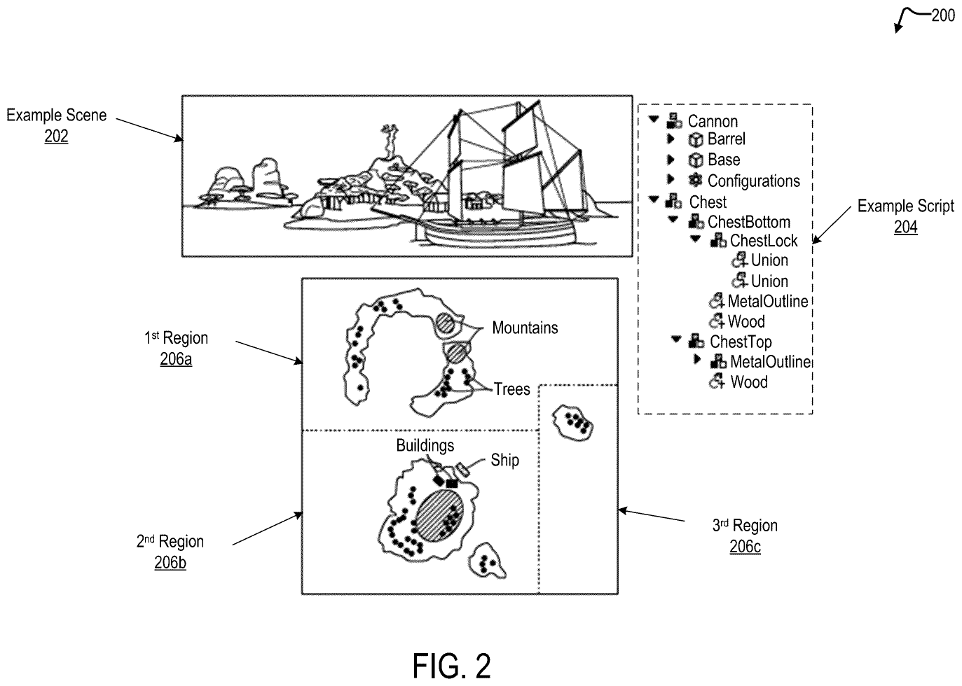

FIG. 2 is a diagram of an example virtual experience 200 partitioned into regions, in accordance with some implementations. As used herein, a “region” may refer to an area of the virtual experience 200 that contains groups of interacting models and/or individual models that generally do not interact with outside models.

Referring to FIG. 2, the top-left portion depicts an example scene 202 (a battleship scene) from the virtual experience 200 that includes multiple island models and a ship model. The top-right portion of FIG. 2 depicts an example script 204 that defines the behavior of the models (e.g., ship, cannon, chest, etc.) in the scene. The bottom portion of FIG. 2 illustrates the partitioning of the scene 202 into different regions, using scene 202. In the non-limiting example of FIG. 2, the scene 202 may be divided into a first region 206a that contains two landmasses that each include a mountain and trees, a second region 206b that contains a ship and another landmass with buildings, trees, and a mountain, and a third region 206b that contains yet another landmass with trees. In some implementations, each of the first region 206a, the second region 206b, and the third region 206c may be managed by different virtual experience servers or two or more of the different regions may be managed by the same virtual experience server since these regions are contiguous.

In this example, a user can take one of two roles. The first role may be that of a player, in which a user accesses the platform to interact with a virtual world and the other players in it. The second role may be that of a creator, in which the user develops a virtual world of their own and publishes it on the platform for players to enjoy. The same user can take both roles at different times. At a high level, an experience may include models and scripts.

A model may be an individual virtual object, such as a ship. A model may be typically formed from several parts, such as cylinders, boxes, spheres, meshes, textures, and a set of constraints. For instance, a constraint might specify that two parts of a model are attached to each other (e.g., a sail and a mast), or that they should be able to rotate around one another (e.g., the ship's wheel rotates around a spindle). Models, parts, and constraints may also have a number of properties, such as the color and texture of a model part.

Scripts may be used to define the models' behavior. For instance, the example script 204, which corresponds to the ship, may cause the ship to change directions when a player turns the wheel. Example script 204 use a document object model (DOM)-like data model to interact with the example scene 202. Explained in another way, a script can read and write properties (e.g., the ship's current position), and it can create or destroy models or their parts and constraints. For example, if the ship is struck by a cannonball, the example script 204 may destroy the ship's model if the ship sinks. Scripts can also subscribe to events, such as one model touching another, and they can define event handlers (e.g., a cannon is fired in response to a player lighting its fuse). A complex script can contain thousands of lines of code, and a virtual experience can contain many complex scripts. Note that script segmentation may contain distinct groups of connected objects, and that the data model tree of the example script 204 may be semantic and not strictly spatial.

Virtual experiences may run in a simulation that periodically or otherwise repeatedly computes a new state of the virtual world, which is then rendered and displayed to the players. For instance, the simulation might compute a new frame 60 times per second for a 60 fps framerate display; this corresponds to an inter-frame delay of roughly 16 milliseconds (ms). However, other framerates may be used based on various factors including user-device capability, server capacity, etc. For ease of exposition, this process is described below as if it ran on a single machine, before describing a distributed simulation.

For a single machine, computing a new frame includes two example steps. The first is a physics step, which makes models generally follow the basic laws of mechanics. For instance, once the cannon in the present example has been fired, the ball will automatically follow a ballistic trajectory, based on its weight and the original impulse; the creator does not need to write code for this basic behavior. The second step is the script step, which executes all active scripts. A script can be activated periodically (or otherwise) or by events generated in the physics step (e.g., such as collisions or player inputs).

The physics step may include three example sub-steps. First, a broad phase determines which pairs of models are proximate enough so that interactions therebetween may occur (e.g., by intersecting rough bounding boxes around them). Second, a narrow phase checks whether any pair(s) of models actually interact. Electromagnetic forces are typically not simulated, and gravity may be applied uniformly, so interactions happen via constraints or direct contact. This partitions the models into physics island(s). As used herein, a “physics island” may include a set of objects that influence each other directly via the laws of physics. Each region may include one or more “physics island(s).” Next, the platform constructs a set of linear equations that describe the intended behavior of the corresponding physics island (e.g., that two parts with a fixed connection should always have the same position relative to each other, or that a collision should preserve momentum). Further, each set of equations is submitted to a physics solver that computes the positions, angular and linear velocities, etc. of the relevant models in the next step.

In a multi-player experience, each player has his or her own client device, which accepts inputs from its associated player and periodically renders a view of the experience from that player's perspective. Since the players are able to see the same virtual world, the client devices exchange information over the network. This leads to two additional challenges.

First, the network has limited bandwidth and nontrivial propagation delays, which may be larger than the inter-frame delay. Thus, a client device may not be aware of all the changes by the time it has to render the next frame. And second, a client devices has finite memory and computation power that may be insufficient to run the entire simulation, even in the aggregate. Thus, the simulation is necessarily distributed (e.g., no client will know the entire, current state of the world) and will typically include additional virtual-experience servers that provide extra resources and/or help to coordinate the simulation. The term “nodes” as used herein may refer to a client device(s) and a virtual-experience server(s).

Let M be the number of models and scripts, and P be the number of players. The present disclosure provides a virtual experience platform with for example: 1) an unlimited scale (there is no fixed limit on Mor P, if enough virtual-experience servers are available), 2) efficiency (the number of servers grows roughly with O(M+P)), and 3) offloading (client devices perform at least part of the computation).

To provide a virtual experience platform with the above-mentioned characteristics, the present disclosure assumes the following: 1) an upper bound on the number of parts and constraints in a model, 2) the total script workload is at most linear in M and P, and 3) the computational workload is reasonably distributed in the virtual experience.

At first glance, scaling virtual worlds may not appear like a systems problem. However, the core problem is essentially data management; namely, there is a data set (the current state of the virtual world) that continuously evolves by a set of continuous queries (e.g., physics, scripting, and player inputs), and the goal is to periodically output a view of this data on each client device (rendering). To that end, various implementations described herein provide a distributed database. The present distributed database has a workload that is strictly spatial. Namely, there are strong real-time requirements, query processing is heavily distributed, and it natively supports speculation about data that is not yet known.

The workload itself is not scalable: since models can move, each of the M models can theoretically form a physics island with any other model, so the broad pass appears to have O(M²) complexity. Fortunately, this is not the case in practice.

For instance, since most virtual-world platforms simulate mechanics and not electromagnetic forces, a model may generally interact with other models that are in physical proximity to it. Since there is an assumed density limit, there is at most a fixed number of other models can be close enough to interact. With a suitable data structure such as a hash grid, the actual complexity of the broad phase is O(M). The density limit also implies an upper bound on the size of each physics island; so, the per-physics-island computation is O(1), and thus the complexity of the entire physics step is O(M). However, a bigger challenge is the existence of data dependencies.

For instance, if M can be arbitrarily large, it cannot be assumed that any individual node has knowledge of the entire experience, so the models and scripts must be distributed across multiple nodes. However, if different players are all within the same physics island, the physics step requires network communication, which is associated with bandwidth limitations and/or signaling latency.

Fortunately, spatial locality can be used to mask bandwidth limitations and network latency, by managing proximate models using the same virtual-experience server whenever possible. This induces a spatial partitioning of the virtual world, where each node is responsible for a contiguous region; the bottom portion of FIG. 2 illustrates one possible partitioning of a virtual world into different regions. With this approach, communication between different nodes managing the different regions may be performed for models at region boundaries. The density-limit assumption implies that at most a constant fraction of the models are in such region boundaries, so scalability is not an issue.

The above approach has a few additional consequences. Since models can move across region boundaries, there needs to be a way to transfer the management of a migrating model from one node to another. And since such transfers can increase the load of some nodes while decreasing the load of others, the present disclosure provides technique(s) to rebalance the computational workload.

In the present distributed network, this is accomplished by segmenting the virtual world into fixed-size regions, the management of which can be moved to different nodes independently. Finally, to achieve scalability, spatial locality is applied not just to the physics step but also to scripts. This is not the case for other platforms, where scripts can access arbitrary objects anywhere in the virtual world.

Migrating objects between different nodes is a potential source of artifacts. Consider, for instance, what happens when player Alice kicks a ball from one region to another. Once the ball reaches the region boundary, information about the ball must be serialized and sent over the network; but this means that, from Alice's perspective, the ball will briefly stop moving, since the physics simulation cannot cover objects that are currently in transit.

One way to prevent this would be to build a fully synchronous system in which all transmitted objects are received in the same frame in which they were sent. There is no good way to do this, at least not for general-purpose virtual worlds that can contain arbitrary scripts, because it is difficult or impossible to predict the amount of signaling overhead a script might generate in a given frame.

Instead, the present disclosure provides a form of temporal consistency. For instance, the nodes can roughly synchronize their frame numbers and associate objects with the frame in which they were sent. Thus, when an object arrives in a new region, the corresponding recipient node can roll forward the simulation and insert the object in the state in which it would have been had the sender continued to simulate the object while it was in transit.

The overall effect from Alice's perspective is that of a relativistic but otherwise coherent simulation. Namely, the overall state of the world evolves as if it was being simulated by a single server, except that, at any given moment, some virtual-experience servers may not have information corresponding to some recent objects or events and may therefore have an incomplete state of its region.

The obvious problem with the above argument is that, in practice, objects and scripts do interact. For instance, suppose at the exact moment when Alice kicks the ball from an originating region to a destination region, Bob kicks a different ball in the destination region and the trajectories of the two balls happen to intersect. If the simulation processes for Alice's ball, using a method similar to dead reckoning, it may appear that Alice's ball “passes through” Bob's ball instead of properly colliding with it.

To mitigate this type of issue, the present disclosure provides technique(s) that enable the node managing the simulation of Bob's region to 1) roll back time in Bob's region to the frame just before when Alice's ball entered the region, 2) insert Alice's ball to be inserted as of that frame, and to 3) roll time forward again by re-simulating Bob's region as if Alice's ball had been there all along.

In essence, this means that the simulation becomes speculative. In other words, a node computes the state of the virtual world based on the currently available information, but the state is subject to change if and when new information arrives. This is acceptable for a game state in which the main purpose is display to the user; the output commit problem does not exist here. Rollback and re-simulation will cause the collision to happen properly, but they introduce two additional problems.

The first is potential artifacts. For instance, from Bob's perspective, his ball will initially fly straight and then, when the node managing the simulation of Bob's region learns of Alice's ball entering the region, Bob's ball will jump in a different direction. In practice, networked games routinely experience this problem on server-to-client links and have developed a variety of interpolation techniques to mask the resulting artifacts. For instance, Bob's client might not immediately show the ball in its new location but rather move it there slowly, over several frames.

The second problem is, each rollback will waste computational resources if performed naïvely, since the entire simulation is repeated for the affected frames. However, most of this computational workload can be avoided by keeping track of dependencies.

For instance, suppose Alice's ball enters Bob's region at time t−7 and collides with Bob's ball at time t−3. Then, Bob's ball may only be restimulated from time t−3 onward. This is because the appearance of Alice's ball did not affect the simulation during the time period [t−7, t−3].

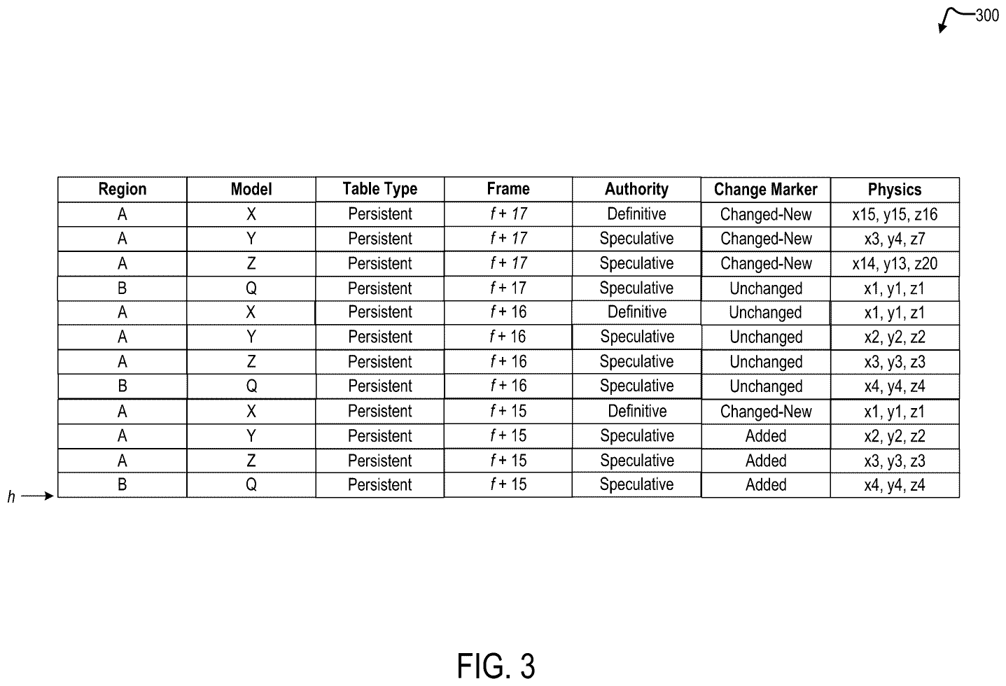

To keep track of these types of dependencies, the present disclosure provides various tables that can be updated and changed by a node to manage the simulation, as described below with reference to FIGS. 3-6.

### First Example Tables

FIG. 3 is a diagram of an example table 300 used for simulating a region of a virtual experience by a node, in accordance with some implementations.

Referring to FIG. 3, a node (e.g., virtual-experience server 102, a coordinator node (which is a type of virtual-experience server), client device 110, etc.) maintains table 300 for models X, Y, and Z, which are located in region A, and for model Q, which is located in region B. In this example, assume 1) regions A and B share a boundary, 2) the node maintaining table 300 coordinates the simulation for region A, 3) region B is managed by another node, and 4) model Q is located in a boundary region (e.g., a predetermined distance from the boundary between regions A and B) of region B.

As shown, table 300 may include multiple rows with unique primary keys. Each row of data is additionally associated with one of several 3D spatial regions, the unit of load balancing. Rows associated with a region contain information about models that are either located in that region (or very close to it). The present disclosure assumes cube region shapes for simplicity, but the present techniques may use any suitable way to associate each region with its neighbors within a fixed radius p.

As also shown in table 300, a node may also maintain different versions of each table, one for each recent frame. Thus, for instance, version 17 of region A in the physics table might contain the positions, linear and angular velocities, etc., of models X, Y, and Z that were in region A as of the 17th frame (f+17). Due to model Q being within the boundary region of region A (but being located in region B), version 17 of the physics table may also contain the positions, linear and angular velocities, etc. of model Q as of the 17th frame. The node maintains the most recent versions of each table, up to a horizon H; any version that is older than H frames may be discarded to reclaim space.

Tables can be persistent or ephemeral: if a value is written to a persistent table as of frame f, it remains in the table for future frames f′ f until it is explicitly deleted, but if the same value is written to an ephemeral table, it only exists in the specific frame f.

Each node (e.g., client device, server, database, etc.) in the system may maintain a copy of the table corresponding to its assigned regions. Different nodes may be assigned different regions, and even if two nodes have copies of tables corresponding the same region (e.g., the regions these nodes manage share a boundary), these copies can sometimes differ.

For instance, suppose Alice and Bob are playing soccer. Their client devices will each have copies of the regions (regions A and B in the present example) that are visible from their avatars, but they are not likely to have a copy of region C that contains Charlie, who is on the other side of a hill in region C.

If Alice kicks the ball in region A, her copy of the region with the ball will reflect the kick at Alice's client device but copy of region A maintained by Bob's client device will not immediately reflect Alice's kick. This is because it takes time for the data to travel from Alice's client device to Bob's client device over the network.

As shown in table 300, each row is annotated with an authority and a change marker. The authority can be DEFINITIVE, AUTHORITATIVE, REPLICATED, or SPECULATIVE; the change marker can be ADDED, DELETED, CHANGED-NEW, CHANGED-OLD, or UNCHANGED. The authority is used to prevent speculative or replicated data from overwriting authoritative data; the change marker is used to incrementally update the data when a node becomes aware of new information.

The authority indicator may be used to convey the certainty of a node's information.

A client device may assign a DEFINITIVE authority to a row corresponding to movements of the player's avatar, so that they cannot be overwritten. An authoritative node (e.g., client device, virtual-experience server, database, etc.) may assign an AUTHORITATIVE authority to any row associated with a model located in the region it manages. An authoritative node performs AUTHORITATIVE writes locally, but the deltas it sends to the replica node(s) (which maintain a replica table for that region) are marked REPLICATED. Replicated tables may be sent to a new node for simulation recovery when a node managing a region corresponding to the replicated table fails or when the region is assigned a new node for load balancing, for example. A node (e.g., client device, virtual-experience server, database, etc.) may assign a SPECULATIVE authority for a row corresponding to a model located in a boundary region or to a model other than the player's avatar in a region in which the player's avatar is also located. An authority label may be included with a delta when a node sends replication deltas to other nodes.

In the non-limiting example of FIG. 3, assume table 300 is maintained by a client device, model X corresponds to the player's avatar (which is located in region A), models Y and Z each correspond to a different model other than the player's avatar in region A, and model Q is a model located in region B but within the boundary region of region A.

Following this example scenario, table 300 has a DEFINITIVE authority marker for model X since table 300 is maintained by Alice's client device. Table 300 has a SPECULATIVE authority marker for models Y and Z since Alice's client device may not have all the information relating to the position and/or trajectory of those models. The authority marker for region B in table 300 is also SPECULATIVE since Alice is not in region B, but region B shares a boundary region with region A. For frame 15 (f+15), table 300 has an ADDED change marker, which indicates that Alice's player has entered region A or that Y, Z, and/or Q first became visible to Alice's player in frame 15. In frames 15 (f+15) and 16 (f+16), Alice's player does not move or interact with other models. Thus, the change marker in frame 16 is UNCHANGED. In frame 17 (f+17), Alice's player interacts with models Y and Z but not model Q. Thus, the change marker corresponding to frame 17 and models X, Y, and Z is CHANGED-NEW, while the change marker corresponding to frame 17 and model Q is UNCHANGED.

When a new server is added to the system, there are at least three options. One is to assign the server a specific region and to have the other servers transfer the corresponding tables for that region in a single large transaction. This may be challenging because there could be quite a bit of state associated with such a transaction. A second option is to do a more gradual transfer to slowly replicate the relevant region to the new server using deltas; and then, when the new server has a (non-authoritative but current) copy of table(s) corresponding to the region to which it is assigned, an authority transfer, which is a single message with a description of the region and an acknowledgment that the sender now considers itself a replica and considers the recipient the authority, may be performed. A third option would be to generally do the second approach but to slowly increase the size of the region the new server is given. The initially assigned region may be a small portion of the region to which it will eventually manage entirely. Over time, more and more objects can be transferred to the new server.

The above authority and change marker description relating to Alice is provided by way of example and not limitation. It is understood that a table may contain any number of rows, where each row corresponds to a different model and frame and includes any appropriate authority and change marker without departing from the scope of the present disclosure.

Furthermore, the tables described herein support five local operations, which affect the tables maintained by the node on which they are invoked. Changes propagate from one node to another as deltas, which are discussed later. The operations are: 1) WRITE(T, ρ, t, k, d, a) set the row with key k to have data d as of time t, creating it if necessary, 2) READ(T, ρ, t, k) return the value of the row with key k, or ⊥ if no such row exists, 3) DELETE(T, ρ, t, k, a) delete the row with primary key k, as of time t, 4) SCAN(T, ρ, t, c) return all the rows with change marker c, as of time t, and 5) COMMIT( ) invoke any triggers and then reset all change markers to UNCHANGED.

Here, T is a table and ρ is a region within that table; WRITE and DELETE operations are associated with an authority a. If a row with the relevant key already exists, the authority of that row controls whether the operation becomes effective: DEFINITIVE has the highest authority and SPECULATIVE the lowest, and operations may only overwrite rows whose existing authority is the same or lower. If the operation becomes effective, the row is updated to have authority a.

When READ is invoked as of time, its return value depends on the effective WRITE or DELETE operation with the highest timestamp tⁱ≤1. If that operation was a WRITE, READ returns the value that was written; if it was a DELETE, READ returns ⊥. If multiple earlier operations have the same timestamp tⁱ, the most recent such operation governs.

### Example Change Markers

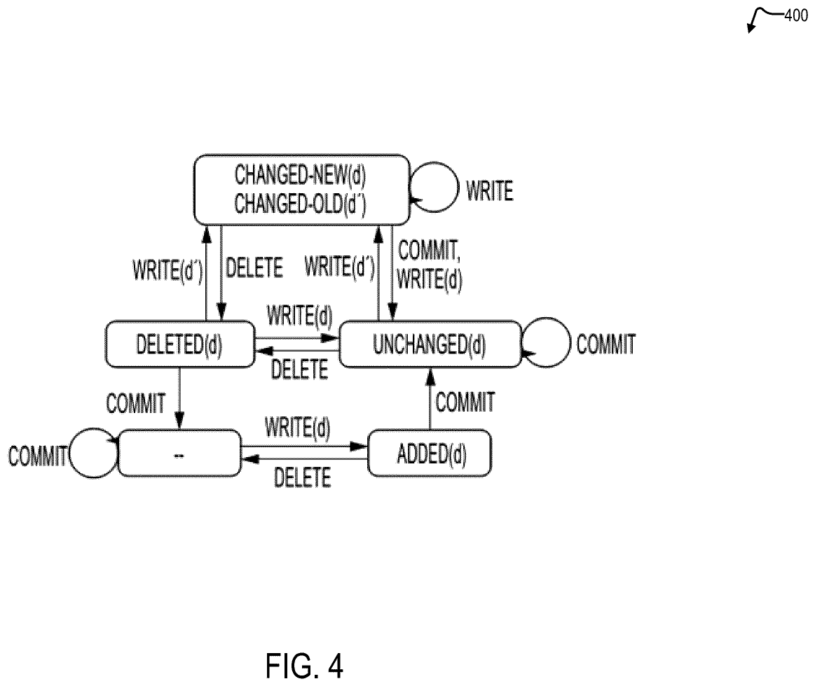

FIG. 4 is a diagram of example change markers 400 for a table maintained by nodes, in accordance with some implementations.

Referring to FIG. 4, WRITE, DELETE, and COMMIT also affect the change marker on the row they access, as shown in FIG. 4. Tables, regions, timestamps, and authorities have been omitted from FIG. 4 for clarity.

The change marker reflects the changes relative to the most recent COMMIT. For instance, if the row has been added since the most recent COMMIT, the marker is ADDED, etc. Modifications of existing rows are special in that they duplicate the row: one copy is marked CHANGED-OLD and contains the row as of the last COMMIT; the other is marked CHANGED-NEW and contains the current value. Further modifications may only affect the latter. A COMMIT deletes any rows marked CHANGED-OLD or DELETED, and it resets all the remaining markers to UNCHANGED.

Change markers may be maintained per version. For instance, suppose an application writes a value A to a key k as of t=10 (e.g., frame 10), and then commits. At this point, the value will exist for all timestamps tᵢ≥10, and it will have the UNCHANGED marker. But suppose that the application now writes value B as of t=12 and then deletes the value as of t=17. Then, the row will continue to have the UNCHANGED marker from t=10 to t=11. From t=12 to t=16, the rows will be duplicated and have CHANGED-OLD markers with value A and CHANGED-NEW markers with value B. For t≥17, they will have a DELETED marker. If the application now commits again and writes C as of t=22, the rows for t≥22 will have an ADDED marker; the rest will be UNCHANGED.

Applications can invoke the five operations mentioned one at a time, but they can also submit two different kinds of parallel computations: continuous queries and triggers. The main difference is that continuous queries run periodically or otherwise repeatedly, whereas triggers run in response to changes in specific tables.

Both types of queries may read from a set of source tables and write to a set of target tables. For each source table, the query also specifies whether it will read the current version of that table or the previous version. When a query runs on a given node as of frame f, the present techniques create a separate instance of the query for each region that exists in at least one of that query's source tables (e.g., the table maintained by the node managing the corresponding region). The instance for a region τ is allowed to: 1) read from any local region in any of the source tables, as of the version the query has specified, and 2) write to region τ in any of the target tables, and as of time t. These specifications exist to create parallelism: the present server and/or database can run all the instances of the same query in parallel, as well as the instances of any combination of queries that access non-overlapping sets of tables. To establish convergence, the present technique(s) may reject any query that would close a cycle.

Continuous queries may run periodically or otherwise repeatedly in each frame, whereas triggers may run when a corresponding source table changes; a change to any source table activates the trigger. When the application calls COMMIT, the present technique(s) identify the earliest version of the table for which at least one trigger is active. Then, the active triggers are executed using one instance for each region that has changes, and all other regions are ignored. As with continuous queries, these instances are executed in parallel whenever possible.

Then, the changes markers in the active triggers' source tables are cleared, which renders the triggers inactive as of the version associated with time/. However, the triggers may have made additional changes to their target tables, potentially activating other triggers. If so, these triggers are executed until there are no more active triggers as of that version. Then, the next-higher version that has active triggers is checked, and the process continues until all the change markers have been cleared.

The above-described example operations may be local: they affect the tables on the node that invokes them. In addition to local operations, the present technique(s) allow applications to send deltas to other nodes. A delta is a short message that corresponds to a WRITE or a DELETE, and it includes all the arguments of these operations; a difference is that the timestamp can have a specific value to indicate that the operation should be applied as of whatever frame is current upon arrival, rather than as of a specific frame. When a node receives a set of deltas, it applies them to its local tables by invoking WRITE and DELETE locally and then calls COMMIT. Each node does this periodically, but at least once per frame.

Deltas can be used to implement several functions. For instance, a continuous query could use deltas to replicate the state of a region to another node-say, from a server to a set of clients—or to migrate models from one node to another. A trigger could use deltas to forward updates, such as local inputs from a client. Several applications of deltas will be described later.

Sometimes a node N₁ may generate deltas for another node N₂ at a higher rate than the network connection between them can accept. In this situation, the present technique(s) triage the deltas to avoid undesirable queueing delays and to prevent the transmission queue from growing indefinitely. To this end, applications assign each delta a priority p. Deltas with p≥0 are in the order in which they have been generated, whereas deltas with p<0 are sent if there is sufficient bandwidth. Moreover, deltas with p<0 are additionally given a maximum queueing delay δₘₐₓ and are dropped once they have been waiting in the sender's queue for δₘₐₓ. δₘₐₓ is not a bound on the end-to-end delay.

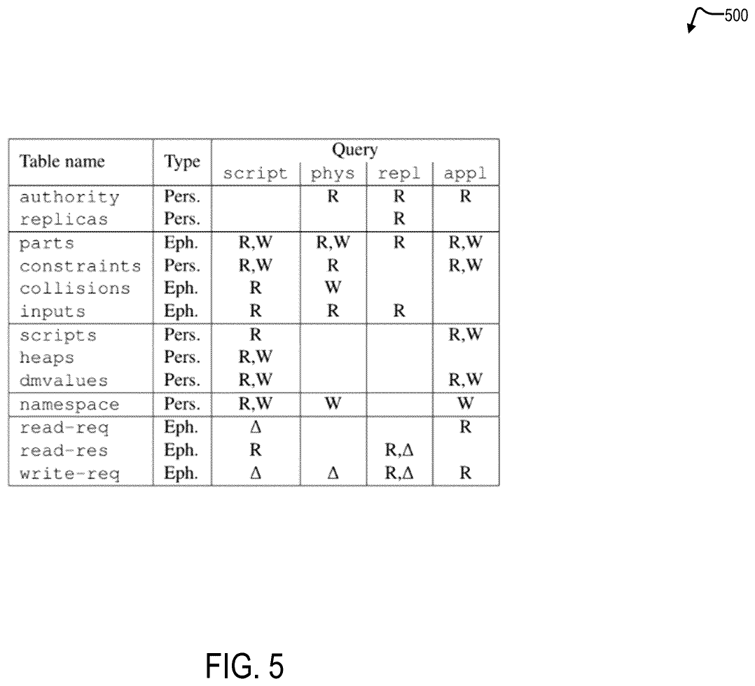

### FIG. 5: Example Tables and Queries

FIG. 5 is a diagram of example tables/queries 500 (referred to hereinafter as “table 500”) implemented by a node, in accordance with some implementations.

As shown in FIG. 5, thirteen example key tables (e.g., authority, replicas, parts, constraints, collisions, inputs, scripts, heaps, dmvalues, namespace, read-req, read-res, and write-req) and four key queries (e.g., script, physics (phys), replicas (repl), and application (appl)) are depicted. The symbols show whether a query reads from a table (R), writes to it (W), or sends deltas (Δ).

The virtual experience platform described herein provides a rich data model with a large number (e.g., over 500) of top-level classes. However, some are less relevant for the present technique(s). For instance, services for making HTTP requests from scripts (Http-Service) or for creating voice chats between players (Voice-ChatService) may be less relevant.

The present technique(s) duplicate the various aspects for scaling in the present text framework: physics, networking, and state are arranged in a data model tree whose nodes are objects with unique object IDs. This ID includes a unique ID for the model to which the object belongs. In this way, the model and its corresponding table can be kept together when migrating from one node to another. The present technique(s) support various types of objects scripts (e.g., Luau scripts or other scripts, one or more of which may execute on a client device and/or a server device). The present framework differs from others to improve scalability. First, the present server(s) and/or database(s) store and replicate the data model. Second, scripts are executed concurrently. The present technique(s) use snapshot isolation, where scripts that run in frame f conceptually start from the same state, and break write-write conflicts based on the object ID of the writer.

In the non-limiting example of FIG. 5, seven persistent tables, six ephemeral tables, and four continuous queries are shown. These tables are explained in several steps, starting with region replication.

For each region in the simulation, a single node (server or client) is AUTHORITATIVE. This node receives all the inputs that are relevant for the region (say, avatar movements) and is responsible for running the simulation. However, other nodes may have a copy of the region as well-either for fault tolerance or, in the case of a client, because the region is close enough to be visible to the player. Such regions are in one of two states: a hot replica or a warm replica.

A hot replica receives (via the “repl” query in table 500) copies of all inputs from the authoritative node and repeats all the simulation steps, whereas a warm replica receives periodic updates of the physics state (e.g., object positions, etc.) and does not do any simulation, other than some basic interpolation. This is a tradeoff between computation and bandwidth: hot replicas may use comparatively less bandwidth because many updates can be predicted locally, whereas warm replicas are associated with less computational complexity and are thus a better fit for resource-constrained devices. However, even hot replicas receive keyframes (e.g., full updates of the physics state) occasionally, since floating-point operations may not be fully deterministic and the state on different devices can diverge over time.

The authority indicator may be used to convey the certainty of a node's information.

For instance, a client device inserts the avatar movements of its associated player into the inputs table as DEFINITIVE, so that they cannot be overwritten. An authoritative node (client or server) performs AUTHORITATIVE writes locally, but the deltas it sends to the replicas are marked REPLICATED. Replicas locally perform SPECULATIVE writes, so they can be overridden by updates from the authoritative node. Since both a node's authority and the set of replicas can change over time, this information is itself stored in the present tables called authority and replicas, so that it can also be versioned. For instance, a node might be authoritative until frame f but become a replica node after that. If the node receives updates after f that pertain to versions before f, this will enable the node to still forward this information to the “old” set of replicas.

The authority and replica tables are controlled by a coordinator node (e.g., a virtual-experience server 102 functioning as a coordinator server), which has two example functions. The first is to maintain a list of regions that currently exist in a virtual world, and to map each region to its authoritative node. Clients contact the coordinator when it joins a virtual-experience experience to find the authoritative node for the spawn point. Clients also contact the coordinator node when a new region becomes visible from its player's location and a table replica of that region is needed. Other nodes also sometimes contact the coordinator (e.g., when an object in its associated region migrates to an adjacent region served by another node). Nodes insert this information into their local replicas table, and it may only be requested again if the local information becomes outdated. When a client device first joins a virtual experience, it receives the corresponding tables (e.g., deltas) from the coordinator node or the virtual-experience server managing the region in which the player's avatar enters.

The coordinator's second function is load balancing. When a node (e.g., a virtual-experience server) has a high computational and/or network workload, it notifies the coordinator. The coordinator may then respond by reassigning some of the regions from that node to other nodes. This is done in two steps.

In the first step, the coordinator assigns the future authoritative node a hot replica, so the node can receive the necessary state. Once this is complete, in the second step, the coordinator transfers authority to the new server (node) by sending deltas to all nodes that have a replica of the relevant region.

Since the coordinator performs administrative functions and need not be on a critical path, its functionality may not be distributed. Architecturally, it represents a potential bottleneck, but this is not likely to become a problem at practical scales, especially since each experience can have its own coordinator.

The physics state is kept in the parts and constraints tables, which are processed by the “phys” query shown in table 500. Each frame begins with a broad phase to find parts that might have collided, based on bounding boxes, followed by a more careful narrow phase to find actual collisions. Since collisions can occur between objects in different regions, instances of these queries read not just from the region for which they have been invoked, but also from the directly adjacent regions, if they exist. The resulting list (collisions) is used in the scripting pipeline to raise collision events.

A particular case occurs for cross-region collisions. Suppose a cannonball in region τ₁ collides with a ship in adjacent region τ₂. Typically, a node that has a replica of τ₁ will also have a replica of τ₂, and vice versa, so the changes can be made directly. However, τ₂ could be at the boundary of regions served by two different servers, or at the boundary of a given client's region of interest, and without a local copy of τ₁, it may not get any such “local” updates. Thus, any such update may be transmitted as deltas via the “write-req” table, which is used generally for all writes to states in other regions. In the interest of concurrency, each instance of a query can write to one specific region, in some instances. If the remote region is on the same server, these deltas are applied locally; otherwise, they are sent over the network to the node managing the simulation for that region. The “appl” query in table 500 applies these updates to the tables for the next frame.

In addition, the “phys” query in table 500 may be used to check whether each model has moved too far away outside the local region. A small excursion into an adjacent region is acceptable, since the broad phase includes adjacent regions anyway, but eventually, the computations associated with the model and its corresponding table should be transferred to a new region. In this case, the query writes the model to the “write-req” table, from where it is transferred to the destination node.

The script state is kept mostly in the scripts and heaps tables. Scripts contain the bytecode for each script in the local region, whereas heaps contain the values in each script's long-term heap. The keys in heaps includes two example parts: key H(s).x contains the value of object x in the heap of script s, where H is a hash function. The special key H(s). 0 contains the current context of the script, including its stack, program counter, and any external conditions on which the script is currently blocked. Notice that in table 500, in contrast to parts, heaps is persistent and is not recomputed from scratch each frame.

To reduce the load on the present distributed system, generational garbage collection may be implemented in some implementations. For instance, when a script executes in a given frame, new instances are first allocated in a short-term heap; values that are still alive at the end of that frame are then migrated to the actual heaps table, and the rest are erased. With this approach, temporary values are discarded quickly and rarely make it to the long-term heap.

The “script” query in table 500 may be used to execute scripts that are ready to run or have at least one pending event. A challenge here is handling accesses to the data model: scripts can access parts, constraints, scripts, as well as a special table for additional properties called dmvalues. If a script newly creates an entry or accesses one that exists in the local region, this is relatively easy, since the entry can be accessed directly. Reads are satisfied either directly from the persistent tables or from the “write-req” table (if an entry already exists there), so that scripts can read their own writes.

The instance in which a script accesses a data-model object outside the local region is also supported by the present techniques. A separate global directory maps each object ID to the following: 1) the object ID of its parent (if any), 2) the names and object IDs of its children, and 3) the node(s) that have recently been authoritative for this object, along with the frame number at which their authority began. The global directory is updated whenever an object is created, deleted, moved to a new location in the data-model tree, or migrated to another node. Migration to a different region managed by the same node does not require an update. The global directory can be implemented as a normal key-value store, perhaps even by the same nodes that also manage those regions, so scalability should not be a concern.

Each node maintains a local cache of global-directory entries, as well as a local directory that maps the object IDs of a region's locally resident objects and is stored in region 0 of a special namespace table. This enables a two-step approach to remote data-model accesses. In a first step, when a node has an entry for an object ID i in one of its tables, the node looks up i in the local directory. Then, in a second step, if i is not found in the local directory, the node looks up i in the global directory (which will incur a network round-trip time (RTT)). Once the authoritative node is known, the sending node sends the access as a delta to the authoritative node, using either read-req (for reads) or write-req (for writes). Read results are returned via a delta to the read-restable.

In principle, read results could be returned as of the same frame where the read was issued. However, if a script issues multiple remote reads, this may cause repeated rollbacks, and eventually the results may arrive behind the horizon and could no longer be processed. Instead, these deltas can be sent with a unique symbol as the timestamp, so they are applied to whatever frame is current upon their arrival. The effect is that accesses to region-local objects in the data model may be substantially instantaneous, whereas accesses to remote objects can take some time. The majority of accesses may be local using the present technique(s).

### Example Trigger for Query

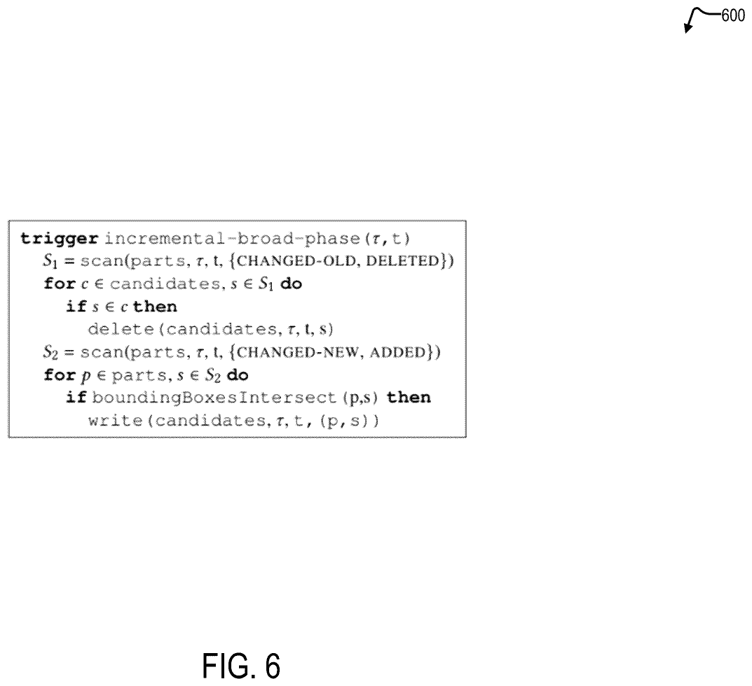

FIG. 6 is a diagram of an example trigger 600 for a broad-phase query, in accordance with some implementations.

So far, continuous queries have been discussed. However, in practice each continuous query may be associated with a trigger that has the same source and target tables and is responsible for incremental updates. As discussed above, continuous queries may run once per frame and compute their target tables entirely. If one of the source tables is modified later, perhaps by an incoming delta, the query may produce a different result if it were re-run; but re-running the entire query would be wasteful, especially if the changes are small. A function of the trigger is to achieve the same effect with reduced computational complexity. Typically, this involves identifying changes in the source tables and then updating the target table to reflect these changes.

As an example, FIG. 6 shows pseudocode for the part of the “phys” trigger that implements the broad phase. The broad phase involves an all-pairs comparison between the parts in a region and its direct neighbors to identify a set of potential collision pairs. If a new part is added to the region afterwards, all the computations are not recomputed; instead, only a comparison of the new part to all the existing parts may be performed. If an existing part is deleted, it can be removed from the collision pairs it was a part of. If a part is moved, it can be treated as a deletion followed by an addition.

Cascades and loops may be a concern with this approach. Fortunately, loops may not occur because the data flow is acyclic. Cascades can occur, in the sense that a single change can trigger multiple additional changes but are typically limited by spatial locality and the velocities of objects. Suppose a region contains multiple billiard balls and a node managing that region learns a new ball comes in from another region as of eight frames ago. In this example scenario, the new ball may hit some other balls and change their positions, these balls may then hit even more balls, etc. However, all of these changes are limited by the speed of Newtonian mechanics. At 60 fps, eight frames corresponds to

$$n \cdot 1 / \frac{60}{s} = 133 ms ,$$

and since the top speed of a billiard ball is roughly

$${v}_{max} = 11.6 \frac{m}{s} ,$$

the changes can affect at most an area with a

$$n \cdot {v}_{max} / \frac{60}{s} = 1.55 m radius ,$$

which may be a tiny fraction of a region.

Different regions may use different amounts of resources for simulation. For instance, a region that contains a large naval battle may use more resources than a region that contains empty sea. However, two large fleets might meet on the empty-sea region and start a battle. Because of this, the assignment of regions to nodes may be adjusted to balance computational workloads associated with the naval battle in the previously empty-sea region. This process has four goals: 1) each of the client devices has replicas of the regions visible to its player, 2) no node manages more regions than it can simulate within a threshold-degree of performance, 3) no region exists only on a single client, and 4) each node manages a contiguous region or regions.

The benefits of the first two goals can be readily seen. The third is beneficial for fault tolerance: client devices are less reliable than servers and can leave the system without warning, so the system may be prevented from losing tables when a player exits the virtual world. The fourth goal is subtle, but critical for performance; namely, signaling overhead occurs mainly for regions that have at least one neighbor on another node, since this requires network communication and potentially incremental updates due to network latency. Hence, it is useful to minimize/reduce the number of such regions and assign adjacent regions to the same node for management whenever possible.

Some implementations may use a greedy heuristic to pursue the fourth goal. When a node reports a high workload, then, for each region τᵢ on the border of that node's region, and each server Sⱼ that contains a region adjacent to τᵢ, a score is computed that depends on 1) the current computational load of τᵢ, 2) the number of deltas t, recently sent to adjacent regions, and 3) the current load on Sⱼ. A set of regions with high scores may be transferred to the relevant servers, via the above-described process.

Various implementation details are provided below.

Front-end: To provide a realistic case, a frontend is implemented for the XML-based data format. Thus, the same code may be executed in the implementations described herein to verify that the behavior is the same. As previously mentioned, a subset of API may be used, and experiences that use this subset can be loaded and run.

Platform: The implementations described herein are structured so that the same code can run on real hardware and in an event-driven simulator. When running on real hardware, it may use wall-clock time for frame synchronization and Transmission Control Protocol/Internet Protocol (TCP/IP) for networking; when running in simulation, it may use virtual time and a simulated network. The present network simulation contains both bandwidth constraints and simulated latencies.

Scripting: The scripts may be written in a programming language. In a non-limiting example, a virtual memory may be implemented that is compatible with the bytecode generated by the compiler that compiles scripts but that maintains its long-term heap in the present distributed server/database system. Generational garbage collection is supported to reduce the amount of heap state that needs to be stored.

Physics: A broad phase may be implemented based on bounding boxes, as well as a simple islandizer. For physics, a rigid-body simulator that includes a solver may be used. To avoid the cost of invoking a rigid-body simulator in the common case, fast paths for collision-free individual objects may be used, as well as the common two-body sphere-sphere and sphere-box collisions.

Workload: A parameterized stress-testing world Volcanoes (T) with approximated T regions was used for experimentation. This world contains: 1) a grid of |\sqrt{T}|×|\sqrt{T}| region-sized ground blocks, 2) T “volcano” blocks across the entire world, and 3) an eruption script instance for each volcano that emits a stream of moving “rocks” from the top. Rocks spawn with random velocities and are deleted after time, so that at most 20 are present per volcano, for a total of 20T moving objects per world, for example. This is a complex scenario because the rocks trigger constant updates to the present distributed server/database system, and many cross regions boundaries require migration.

Approach: Experiments were run in simulation. The simulator runs one frame at a time, so accurate frame time measurements are obtained using wall-clock time. For network latencies, virtual time was used; a bandwidth of 10 gigabits per second (Gbps) was simulated between the servers and 10 megabits per second (Mbps) was simulated from the servers to the clients. Measuring memory consumption and network traffic is straightforward.

Hardware: The experimental results were measured on a server with four 2.8 GHz 16-core CPUs and 512 GB RAM with two threads per core. This is representative of virtual-world platform data center hardware.

### Scalability Versus Number of Online Virtual Experience Servers

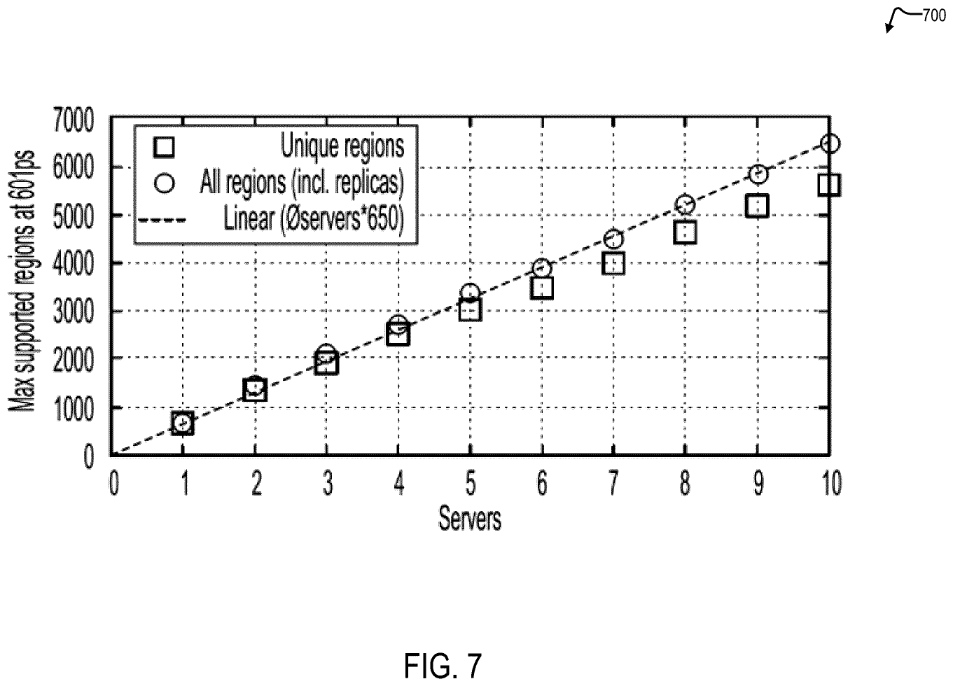

FIG. 7 is a graphical illustration of database scalability 700 with the number of supported regions plotted against the number of online virtual experience servers, in accordance with some implementations. A hypothesis is that it is possible to achieve generally limitless scalability for virtual worlds. To test whether the present distributed server/database system achieves this, S=1 . . . 10 virtual servers were instantiated, and the largest total number of regions Tat which each server achieved 95th-percentile frame time below 16.7 ms (e.g., can sustain a 60 fps frame rate) were measured. To account for replication, the number of unique regions Tⁱ were also measured.

FIG. 7 shows examples of the results with separate lines for T and Tⁱ. Both grow linearly with S. This happens because the overhead is primarily due to replication. Consider the case of an n×n square of regions assigned to a server. This region has O(n²) area and O(n) perimeter. Replication may only occur at the perimeter, so for large n the area term dominates, and replication effects are negligible for scaling. Without loss of generality, this consideration applies to any shape of regions that have relatively simple geometric boundaries and are mostly contiguous. If the regions were instead poorly load balanced by being spatially assigned in a checkerboard manner or with a fractaline boundary, then the perimeter could be O(n²) and replication would continue to dominate in the limiting case.

For S≤7, Tⁱ grows faster with S. This is because, for small values of S, many servers are assigned a region at the “edge of the world,” and regions along this edge do not need to be replicated.

### Consistency of Data Movement per Server

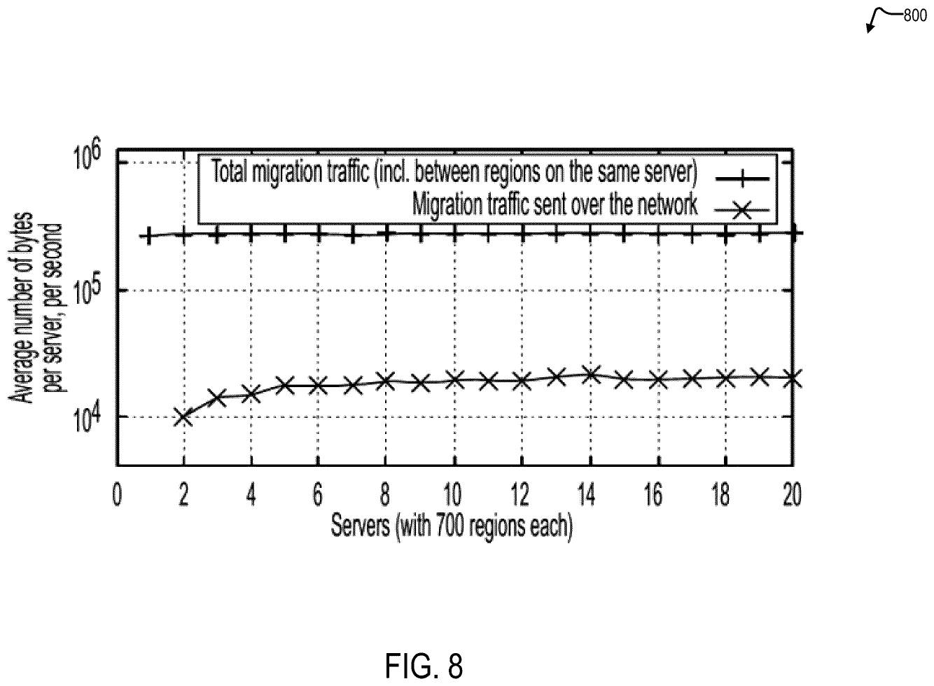

FIG. 8 is a graphical illustration 800 of consistency of data movement per server, in accordance with some implementations.

Another source of overhead is bandwidth. To implement a single coherent virtual world on multiple servers, the servers exchange messages to coordinate. For instance, nodes use network bandwidth to perform one or more of the following: 1) migrate objects from one server to another due to object mobility, 2) access remote parts of the data model from scripts, 3) replicate regions, and 4) access the global directory. To measure these overhead signaling costs, Volcanoes (T) was simulated with different numbers of servers S, keeping the number of regions per server constant. The amount of bandwidth associated with each server was measured during the simulation.

FIG. 8 shows example results for object migration with separate lines for the total migration traffic between regions and the migration traffic transmitted over the network. Since migration occurs at region boundaries and the rate at which rocks cross such boundaries is fairly stable, the total amount of migration traffic per server is stable as well; recall that, in this experiment, each server is assigned the same number of regions. This is good news for scalability. Moreover, since the servers manage contiguous region(s), most migrations occur between regions assigned to the same server, so only a tiny fraction of them (about 7% for S=10) may be sent over the network.

Notice the vertical axis in FIG. 8 has a logarithmic scale. The fraction initially increases but eventually stabilizes. This is due to the same boundary effects: some of the regions are next to the “edge of the world,” and objects that approach this edge cannot be migrated. For small values of S, the fraction of such regions is greater, so the number of migrations is correspondingly smaller. The results for the three other sources of bandwidth are similar, since all are driven by activities in boundary regions, and are not shown here.

### Memory Consumption Versus Number of Regions

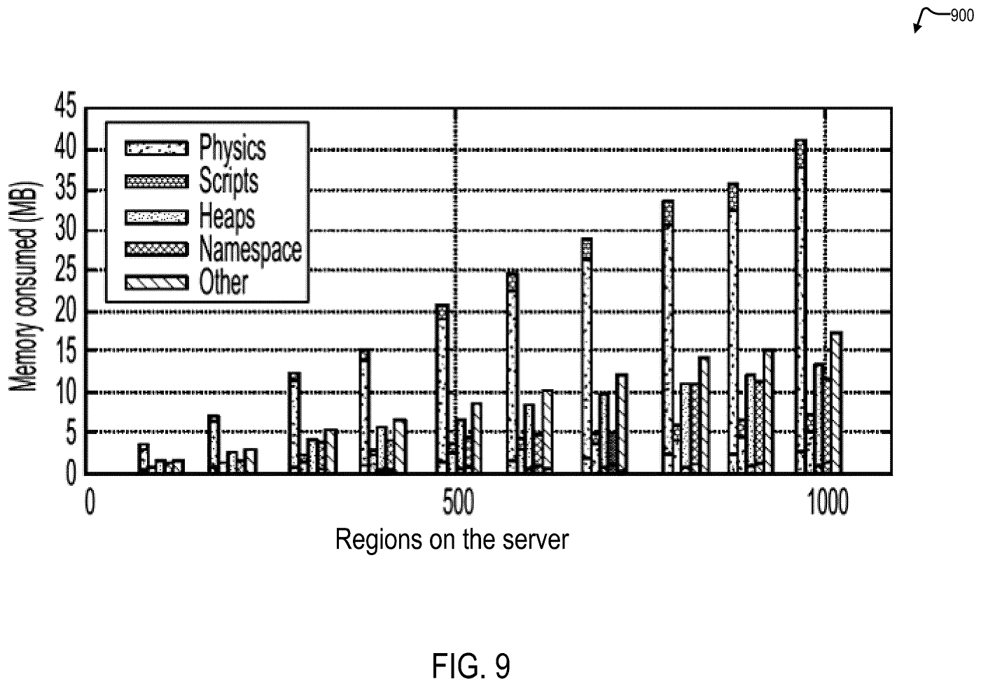

FIG. 9 is a graphical illustration 900 of memory consumption versus the number of regions on an online virtual experience server, in accordance with some implementations.

Like any in-memory database, the data maintained by the present distributed server/database consumes space. However, the present system also maintains some past table versions, so memory consumption is higher. In one case, there may be H copies of every item.

To quantify this cost, operations were run with a single server and different numbers of regions T. The following were measured: 1) the total amount of memory (including for metadata and indexes) consumed, 2) the amount of memory used to store table data, both in the current frame and in earlier frames, and 3) the amount of table data just in the current frame.

FIG. 9 shows example results as groups of stacked bar graphs, with one group for each setting of T and separate stacks for the biggest tables (e.g., physics, heaps, and the local directory), plus a combined stack for the rest. In each stack, the top shows overhead, the middle shows data from earlier frames, and the bottom shows current data.

Overall, all three measures of memory consumption increase linearly with the number of regions. This happens because the same is true for the amount of raw state (shown at bottom of each stack). Recall that, at any given time, each region has one base plate, one volcano, and roughly 20 rocks (plus or minus rocks that have rolled out to, or in from, adjacent regions), so, with 119-byte parts rows, the physics state per region is only about 2.5 kilobytes (KB). The script on each volcano does keep a reference to its current rocks, but these references are overwritten once the corresponding rock is deleted.

Most of the space is consumed by data from earlier frames (e.g., when a 250 ms horizon is used, h=15), with some additional overhead for the hash-based index used. Despite this, the total amount of memory is negligible compared to the space available in a modern server. Even with T=1,000 regions, the present server uses about 81 megabytes (MB) of memory. The physics workload causes the present server to run out of central processing unit (CPU) cycles well before it runs out of memory. This is partly due to the workload, which was designed to stress physics and inter-region mobility. A workload with more passive objects (scenery, buildings, etc.) would consume more. However, the server used 512 gigabytes (GB) of random-access memory (RAM), so the number of objects would have to be increased by almost four orders of magnitude to cause the server to run out of memory.

### Replication Traffic Versus Number of Regions

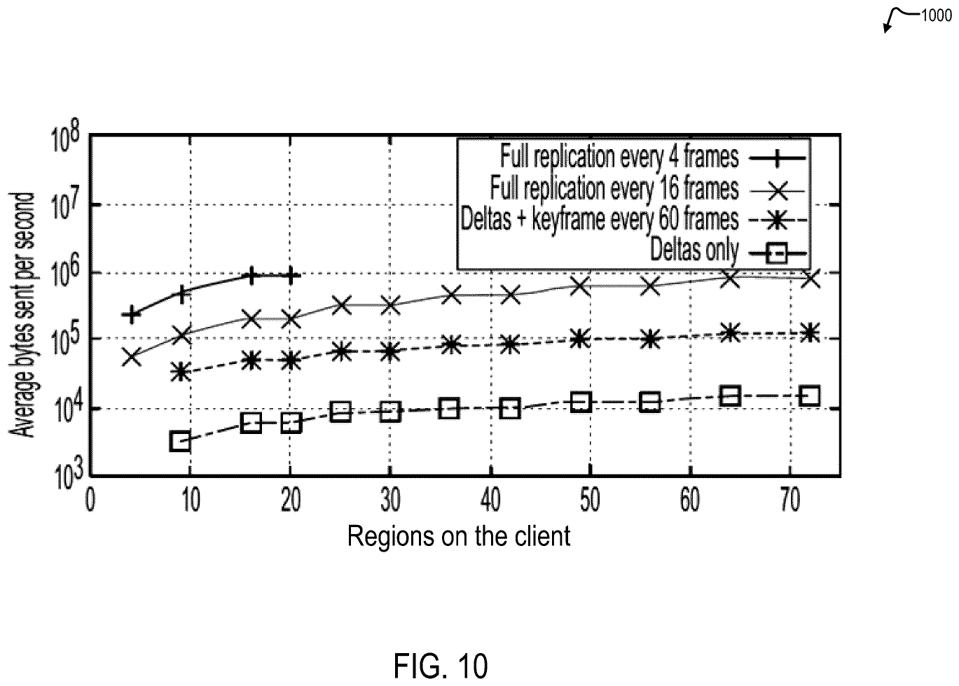

FIG. 10 is a graphical illustration 1000 of an amount of replication traffic versus the number of regions on the client, in accordance with some implementations.

For some virtual world platforms, client devices do not maintain a copy the entire game state but rather a “region of interest” around the player's current position. Some systems use warm replication for this; that is, they send a full physics update (the current positions, velocities, etc., of all active objects) to each client device once every k frames.

In comparison, the technique(s) provided herein also uses hot replication and sends nondeterministic events, such as incoming migrations or user inputs, and for regions on the boundary of the client's current region of interest. To quantify the impact this has on replication bandwidth, operations were run with a single server running Volcanoes (196) and a single client device that is interested in regions of different sizes, between 5 and 75 regions, using either hot or warm replication. The average amount of traffic per frame was measured that was sent from the server to the client.

Results indicate that warm replication consumes a comparatively large amount of bandwidth, which increases with O(1/k). Hot replication reduced the bandwidth consumption by roughly two orders of magnitude, relative to k=4; even if full “keyframe” is added once per second (k=60) to correct divergence that might arise from floating-point unit (FPU) differences, the savings are still roughly an order of magnitude. The downside is that the client device simulates the corresponding regions locally. The overall scaling behavior is the same as between servers: bandwidth grows linearly with the number of regions on the client. However, the constant factor depends either on the number of active objects on all regions (warm) or on the number of nondeterministic events on boundary regions (hot).

The above-described results show that some costs scale linearly with the size of the experience, indicating that present distributed server/database system enables a metaverse platform to scale without bounds: doubling the number of servers and network capacity enables doubling the size of the world. For clients with a fixed-size region of interest, the server-to-client bandwidth scales linearly with their number. In absolute terms, hot replication can reduce the bandwidth by one to two orders of magnitude.

A widely held belief in the gaming industry is that virtual-world workloads are very difficult to scale. Indeed, most of the current platforms are limited to contiguous virtual worlds with at most a hundred players. However, using the present technique(s): virtual-world workloads can scale linearly, if they run on a data management system that is tailored for their needs and can use their unique spatial structure to its advantage.

### Example Method(s) of Managing a Simulation of a Virtual World by a Coordinator Node

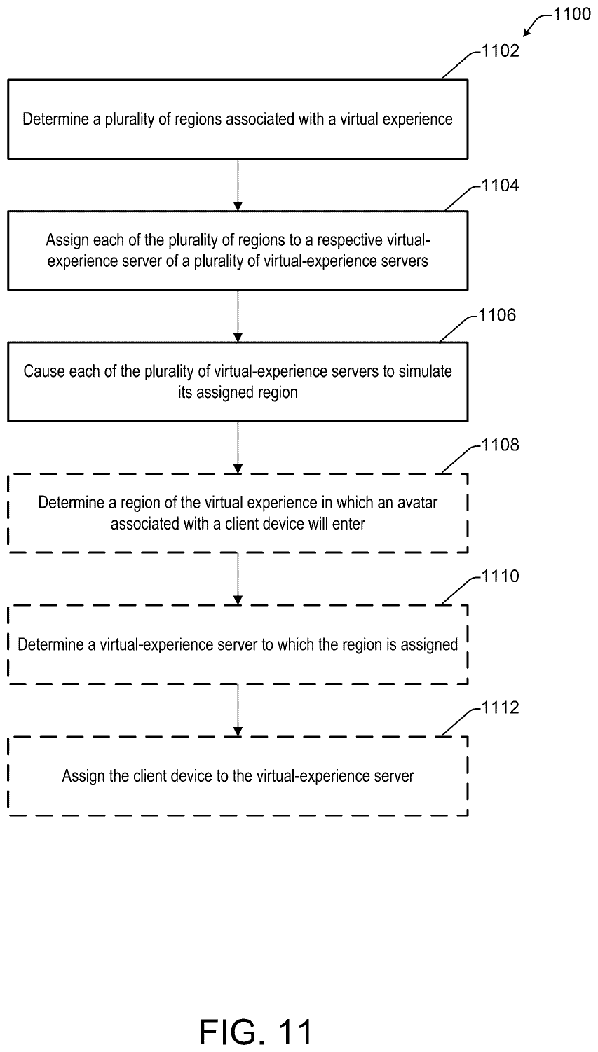

FIG. 11 is a flowchart of an example method 1100 of mesh-deformation prediction, in accordance with some implementations.

In some implementations, methods 1100 can be implemented, for example, on an online virtual experience server 102 (e.g., by a virtual-experience coordinator) described with reference to FIG. 1. In some implementations, some or all of the method 1100 can be implemented on one or more client devices 110 as shown in FIG. 1, on one or more developer devices (not illustrated), or on one or more online virtual experience server(s) 102, and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the method 1100. In some examples, a first device is described as performing blocks of method 1100. Some implementations can have one or more blocks of method 1100 performed by one or more other devices (e.g., other client devices or server devices) that can send results or data to the first device.

In some implementations, method 1100, or portions of the methods, can be initiated automatically by a system. In some implementations, the implementing system is a first device. For example, the method (or portions thereof) can be periodically performed, or performed based on one or more particular events or conditions, e.g., upon a user request, one or more times per frame, upon a user entering a region or moving to a new region, upon a predetermined time period having expired since the last performance of method 1100 for a frame, and/or one or more other conditions occurring which can be specified in settings read by the methods. In FIG. 11, optional operations are indicated by dashed lines.

Referring to FIG. 11, method 1100 may begin at block 1102. At block 1102, a plurality of regions associated with a virtual experience is determined.

In some implementations, determining the plurality of regions include determining a locality of each virtual-experience model and virtual-experience script in the virtual experience. In some implementations, determining the plurality of regions include grouping the different sets of virtual experience models and virtual-experience scripts into the plurality of regions based on their respective localities within the virtual experience.

Block 1102 may be followed by block 1104. At block 1104, each of the plurality of regions is assigned to a respective virtual-experience server of a plurality of virtual-experience servers.

In some implementations, assigning each of the plurality of regions to the respective virtual-experience server of the plurality of virtual-experience servers includes determining, at a first time, a first workload of a first region and a second workload of a second region. In some implementations, assigning each of the plurality of regions to the respective virtual-experience server of the plurality of virtual-experience servers includes determining, at the first time, a first set of workload characteristics of a first virtual-experience server and a second set of workload characteristics of a second virtual-experience server. In some implementations, assigning each of the plurality of regions to the respective virtual-experience server of the plurality of virtual-experience servers includes, in response to the first workload of the first region not exceeding a first threshold value associated with the first set of workload characteristics, assigning, at the first time, the first region to the first virtual-experience server. In some implementations, assigning each of the plurality of regions to the respective virtual-experience server of the plurality of virtual-experience servers includes, in response to the second workload of the second region not exceeding a second threshold value associated with the second set of workload characteristics, assigning, at the first time, the second region to the second virtual-experience server.

In some implementations, assigning each of the plurality of regions to the respective virtual-experience server of the plurality of virtual-experience servers further may include determining, at a second time, a change in one or more of the first workload of the first region or the first set of workload characteristics of the first virtual-experience server causes the first workload to exceed the first threshold value. In some implementations, assigning each of the plurality of regions to the respective virtual-experience server of the plurality of virtual-experience servers further may include, in response to a third workload of a portion of the first region combined with the second workload of the second region not exceeding the second threshold value associated with the second set of workload characteristics, reassigning, at the second time, the portion of the first region to the second virtual-experience server.

In some implementations, the first workload includes one or more of a first computational workload or first latency requirements. In some implementations, the second workload includes one or more of a second computational workload or second latency requirements. In some implementations, the first set of workload characteristics includes one or more of first processing capabilities or first network conditions. In some implementations, the second set of workload characteristics includes one or more of second processing capabilities or second network conditions.

Block 1104 may be followed by block 1106. At block 1106, each of the plurality of virtual-experience servers is caused to simulate its assigned region. The assigned region may include one or more regions. When the region contains more the one region, the regions may be contiguous within the virtual experience.

In some implementations, causing each of the plurality of virtual-experience servers to simulate its assigned region includes sending, to each of the plurality of virtual-experience servers, information associated with virtual-experience models and virtual-experience scripts of its assigned region.

Block 1106 may be followed by block 1108. At block 1108, a region of the virtual experience in which an avatar associated with a client device will enter is determined.

Block 1108 may be followed by block 1110. At block 1110, a virtual-experience server to which the region is assigned is determined.

Block 1110 may be followed by block 1112. At block 1112, the client device is assigned to the virtual-experience server.

### Example Method(s) of Simulating a Region of a Virtual World by a Node

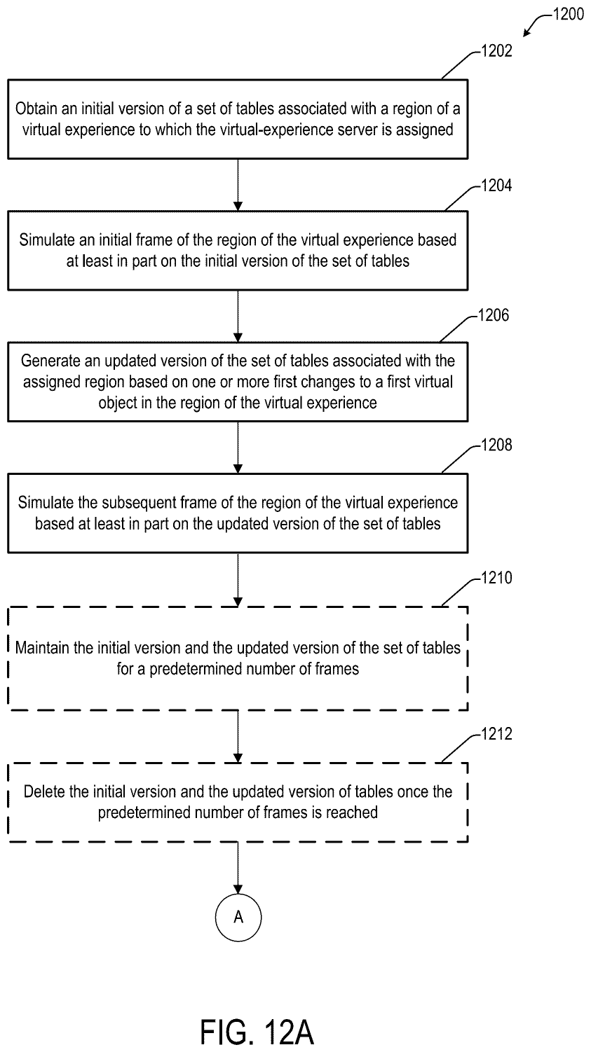

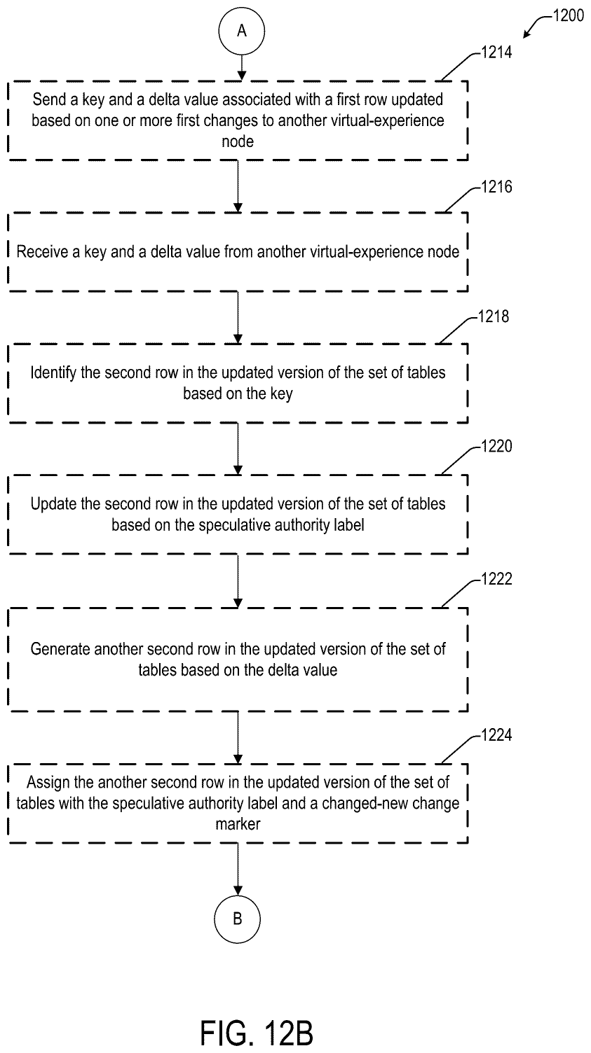

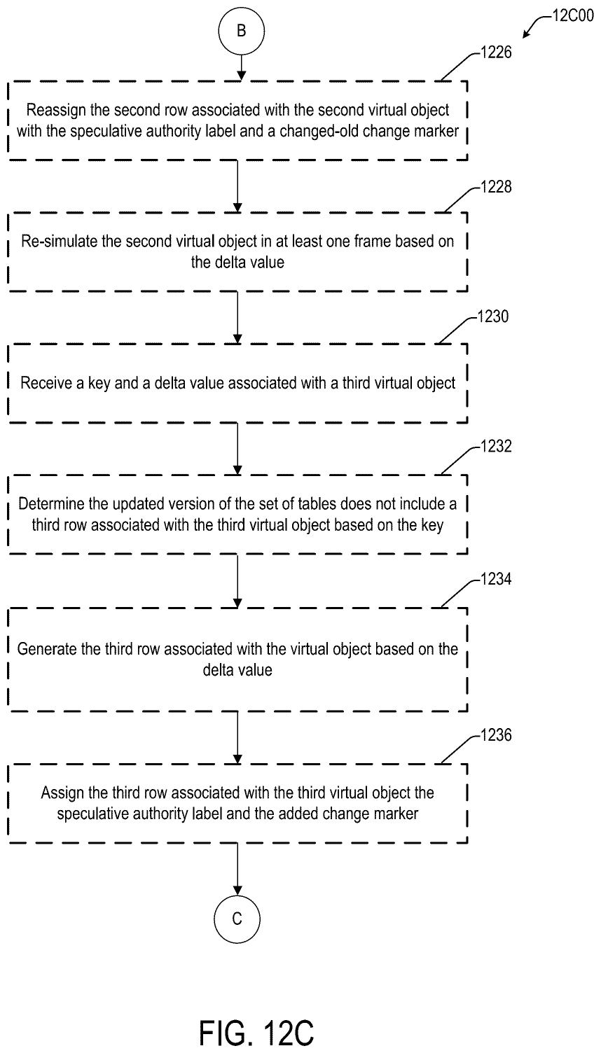

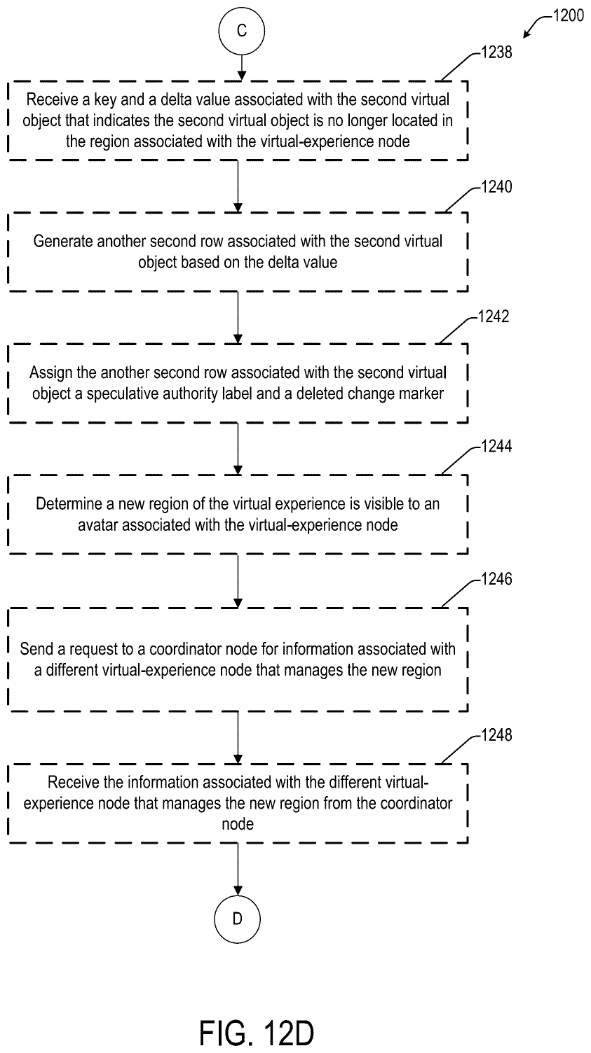

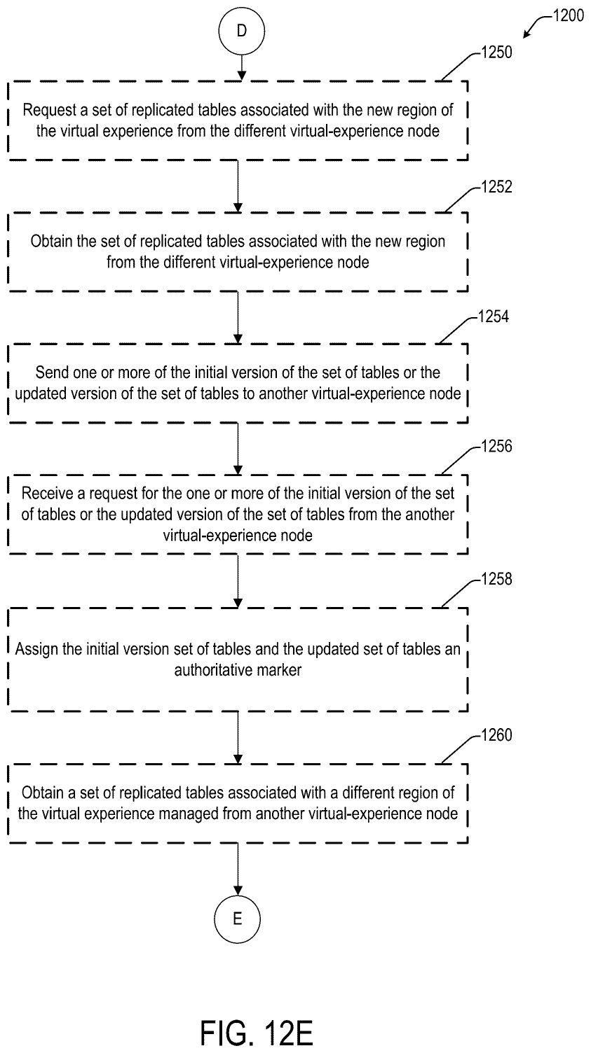

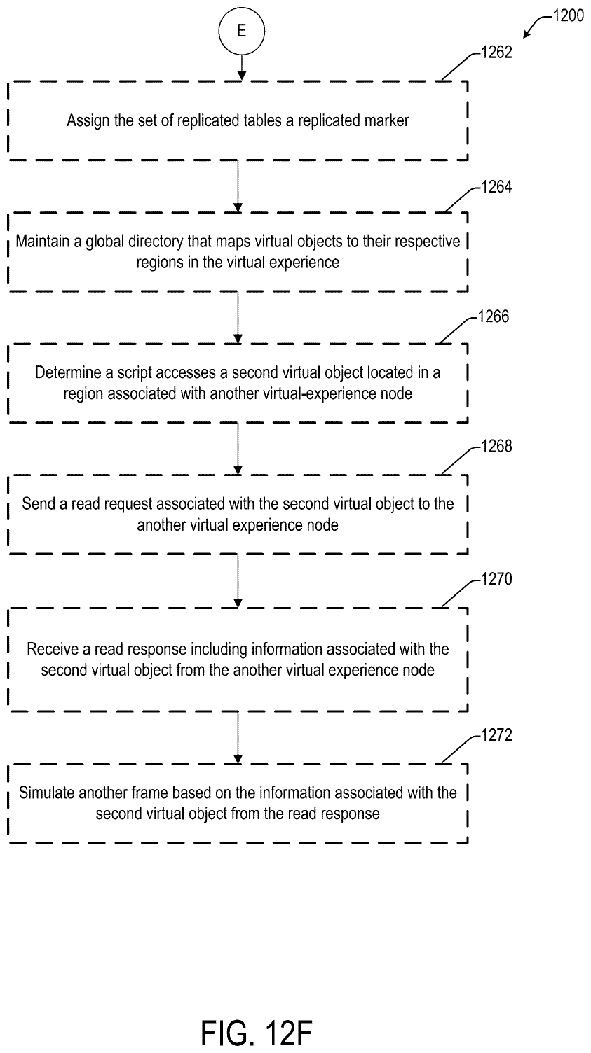

FIGS. 12A-12F are a flowchart of a method 1200 of simulating a region of a virtual world by a node, in accordance with some implementations.

In some implementations, methods 1200 can be implemented, for example, on an online virtual experience server 102 (e.g., by a virtual-experience node) described with reference to FIG. 1. In some implementations, some or all of the method 1200 can be implemented on one or more client devices 110 as shown in FIG. 1, on one or more developer devices (not illustrated), or on one or more online virtual experience server(s) 102, and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the method 1200. In some examples, a first device is described as performing blocks of method 1200. Some implementations can have one or more blocks of method 1200 performed by one or more other devices (e.g., other client devices or server devices) that can send results or data to the first device.

In some implementations, method 1200, or portions of the methods, can be initiated automatically by a system. In some implementations, the implementing system is a first device. For example, the method (or portions thereof) can be periodically performed, or performed based on one or more particular events or conditions, e.g., upon a user request, one or more times per frame, upon a user entering a region or moving to a new region, upon a predetermined time period having expired since the last performance of method 1200 for a frame, and/or one or more other conditions occurring which can be specified in settings read by the methods. In FIGS. 12A-12F, optional operations are indicated by dashed lines.

Referring to FIG. 12A, method 1200 may begin at block 1202. At block 1202, an initial version of a set of tables associated with a region of a virtual experience is obtained. The region is associated with a set of virtual-experience models and virtual-experience scripts. Each table in the set of tables includes a plurality of rows. Each of the plurality of rows corresponds to a portion of the region or a boundary portion that extends into an adjacent region of the virtual experience. Each row contains information associated with a virtual object located in a corresponding portion of the region. Each row in the initial version of the set of tables include a first authority label and a first change marker.

In some implementations, obtaining the initial version of a set of tables includes generating a first row associated with the first virtual object, the first virtual object being an avatar associated with the virtual-experience node. In some implementations, obtaining the initial version of a set of tables includes assigning the first row associated with the first virtual object a definitive authority label and an added change marker. In some implementations, obtaining the initial version of a set of tables includes generating a second row associated with a second virtual object, the second virtual object being a non-avatar virtual object or another avatar associated with a different virtual experience node. In some implementations, obtaining the initial version of a set of tables includes assigning the second row associated with the second virtual object with a speculative authority label and the added change marker.

Block 1202 may be followed by block 1204. At block 1204, an initial frame of the region of the virtual experience is simulated based at least in part on the initial version of the set of tables.

Block 1204 may be followed by block 1206. At block 1206, an updated version of the set of tables associated with the assigned region is generated based on one or more first changes to a first virtual object in the region of the virtual experience. The updated version of the set of tables is associated with a subsequent frame. Each row in the updated version of the set of tables includes a second authority label and a second change marker.

In some implementations, generating the updated version of the set of tables includes updating the first row associated with the first virtual object based on the one or more first changes. In some implementations, generating the updated version of the set of tables includes assigning the first row associated with the first virtual object the definitive authority label and a changed-new change marker. In some implementations, generating the updated version of the set of tables includes maintaining the second row associated with the second virtual object that is unchanged. In some implementations, generating the updated version of the set of tables includes assigning the second row associated with the second virtual object with the speculative authority label and an unchanged change marker.

In some implementations, generating the updated version of the set of tables includes determining the updated version of the set of tables does not include a third row associated with the third virtual object based on the key. In some implementations, generating the updated version of the set of tables includes generating the third row associated with the virtual object based on the delta value. In some implementations, generating the updated version of the set of tables includes assigning the third row associated with the third virtual object the speculative authority label and the added change marker.

In some implementations, generating the updated version of the set of tables includes generating another second row associated with the second virtual object based on the delta value. In some implementations, generating the updated version of the set of tables includes assigning the another second row associated with the second virtual object a speculative authority label and a deleted change marker.

Block 1206 may be followed by block 1208. At block 1208, the subsequent frame of the region of the virtual experience is simulated based at least in part on the updated version of the set of tables.

Block 1208 may be followed by block 1210. At block 1210, the initial version and the updated version of the set of tables is maintained for a predetermined number of frames.

Block 1210 may be followed by block 1212. At block 1212, the initial version and the updated version of tables is deleted after the predetermined number of frames is reached.

Referring to FIG. 12B, block 1212 may be followed by block 1214. At block 1214, a key and a delta value associated with a first row updated based on one or more first changes is sent to another virtual-experience node.

Block 1214 may be followed by block 1216. At block 1216, a key and a delta value is received from another virtual-experience node.

Block 1216 may be followed by block 1218. At block 1218, the second row in the updated version of the set of tables is identified based on the key.

Block 1218 may be followed by block 1220. At block 1220, the second row in the updated version of the set of tables is updated based on the speculative authority label.

Block 1220 may be followed by block 1222. At block 1222, another second row in the updated version of the set of tables is generated based on the delta value.

Block 1222 may be followed by block 1224. At block 1224, the another second row in the updated version of the set of tables is assigned with the speculative authority label and a changed-new change marker.

Referring to FIG. 12C, block 1224 may be followed by block 1226. At block 1226, the second row associated with the second virtual object is reassigned with the speculative authority label and a changed-old change marker.

Block 1226 may be followed by block 1228. At block 1228, the second virtual object in at least one frame is re-simulated based on the delta value.

Block 1228 may be followed by block 1230. At block 1230, a key and a delta value associated with a third virtual object is received.

Block 1230 may be followed by block 1232. At block 1232, the updated version of the set of tables is determined to not include a third row associated with the third virtual object based on the key.

Block 1232 may be followed by block 1234. At block 1234, the third row associated with the virtual object is generated based on the delta value.

Block 1234 may be followed by block 1236. At block 1236, the third row associated with the third virtual object is assigned the speculative authority label and the added change marker.

Referring to FIG. 12D, block 1236 may be followed by block 1238. At block 1238, a key and a delta value associated with the second virtual object that indicates the second virtual object is no longer located in the region associated with the virtual-experience node is received.

Block 1238 may be followed by block 1240. At block 1240, another second row associated with the second virtual object is generated based on the delta value.

Block 1240 may be followed by block 1242. At block 1242, the another second row associated with the second virtual object is assigned a speculative authority label and a deleted change marker.

Block 1242 may be followed by block 1244. At block 1244, a new region of the virtual experience is determined to be visible to an avatar associated with the virtual-experience node.

Block 1244 may be followed by block 1246. At block 1246, a request is sent to a coordinator node for information associated with a different virtual-experience node that manages the new region.

Block 1246 may be followed by block 1248. At block 1248, the information associated with the different virtual-experience node that manages the new region is received from the coordinator node.

Referring to FIG. 12E, block 1248 may be followed by block 1250. At block 1250, a set of replicated tables associated with the new region of the virtual experience is requested from the different virtual-experience node.

Block 1250 may be followed by block 1252. At block 1252, the set of replicated tables associated with the new region is obtained from the different virtual-experience node.

Block 1252 may be followed by block 1254. At block 1254, one or more of the initial version of the set of tables or the updated version of the set of tables is sent to another virtual-experience node.

Block 1254 may be followed by block 1256. At block 1256, a request for the one or more of the initial version of the set of tables or the updated version of the set of tables is received from the another virtual-experience node.

Block 1256 may be followed by block 1258. At block 1258, the initial version set of tables and the updated set of tables is assigned an authoritative marker.

Block 1258 may be followed by block 1260. At block 1260, a set of replicated tables associated with a different region of the virtual experience managed is obtained from another virtual-experience node.

Referring to FIG. 12F, block 1260 may be followed by block 1262. At block 1262, the set of replicated tables is assigned a replicated marker.

Block 1262 may be followed by block 1264. At block 1264, a global directory that maps virtual objects to their respective regions in the virtual experience is maintained.

Block 1264 may be followed by block 1266. At block 1266, a script is determined to access a second virtual object located in a region associated with another virtual-experience node.

Block 1266 may be followed by block 1268. At block 1268, a read request associated with the second virtual object is sent to the another virtual experience node.

Block 1268 may be followed by block 1270. At block 1270, a read response including information associated with the second virtual object is received from the another virtual experience node.

Block 1270 may be followed by block 1272. At block 1272, another frame is simulated based on the information associated with the second virtual object from the read response.

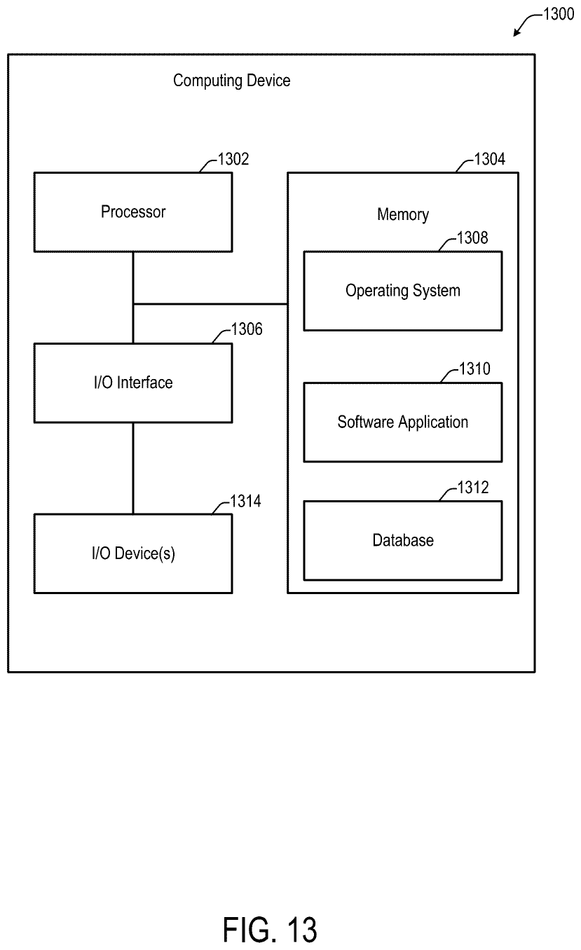

### FIG. 13: Computing Devices

Hereinafter, a more detailed description of various computing devices that may be used to implement different devices and/or components illustrated in FIG. 1 is provided with reference to FIG. 13.

FIG. 13 is a block diagram of an example computing device 1300 which may be used to implement one or more features described herein, in accordance with some implementations. In one example, device 1300 may be used to implement a computer device, (e.g., 102, 100 of FIG. 1), and perform appropriate operations as described herein. Computing device 1300 can be any suitable computer system, server, or other electronic or hardware device. For example, the computing device 1300 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 1300 includes a processor 1302, a memory 1304, input/output (I/O) interface 1306, and audio/video input/output devices 1314 (e.g., display screen, touchscreen, display goggles or glasses, audio speakers, headphones, microphone, etc.).

Processor 1302 can be one or more processors and/or processing circuits to execute program code and control basic operations of the device 1300. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1304 is typically provided in device 1300 for access by the processor 1302, and may be any suitable processor-readable storage medium, e.g., random access memory (RAM), read-only memory (ROM), electrical erasable read-only memory (EEPROM), flash memory, etc., suitable for storing instructions for execution by the processor, and located separate from processor 1302 and/or integrated therewith. Memory 1304 can store software operating on the server device 1300 by the processor 1302, including an operating system 1308, software application 1310, and associated database 1312. In some implementations, the software application 1310 can include instructions that enable processor 1302 to perform the functions described herein. Software application 1310 may include some or all of the functionality described herein.

In some implementations, one or more portions of software application 1310 may be implemented in dedicated hardware such as an application-specific integrated circuit (ASIC), a programmable logic device (PLD), a field-programmable gate array (FPGA), a machine learning processor, etc. In some implementations, one or more portions of software application 1310 may be implemented in general purpose processors, such as a central processing unit (CPU) or a graphics processing unit (GPU). In various implementations, suitable combinations of dedicated and/or general purpose processing hardware may be used to implement software application 1310.

For example, software application 1310 stored in memory 1304 can include instructions for implementing any of the above-described operations and/or techniques. Any of software in memory 1304 can alternatively be stored on any other suitable storage location or computer-readable medium. In addition, memory 1304 (and/or other connected storage device(s)) can store instructions and data used in the features described herein. Memory 1304 and any other type of storage (magnetic disk, optical disk, magnetic tape, or other tangible media) can be considered “storage” or “storage devices.”

One or more of operating system 1308, software application 1310, and database 1312 may provide a distributed database suitable with support for spatial workloads, with capability to handle temporal data, to ensure data consistency, and/or with native support for speculation, per various implementations described herein.

I/O interface 1306 can provide functions to enable interfacing the server device 1300 with other systems and devices. For example, network communication devices, storage devices (e.g., memory and/or data store 120), and input/output devices can communicate via interface 1306. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 13 shows one block for each of processor 1302, memory 1304, I/O interface 1306, operating system 1308, software application 1310, and database 1312. These blocks may represent one or more processors or processing circuitries, operating systems, memories, I/O interfaces, applications, and/or software modules. In other implementations, device 1300 may not have all of the components shown and/or may have other elements including other types of elements instead of, or in addition to, those shown herein. While the online virtual experience server 102 are described as performing operations as described in some implementations herein, any suitable component or combination of components of online virtual experience server 102, or similar system, or any suitable processor or processors associated with such a system, may perform the operations described.

A user device can also implement and/or be used with features described herein. Example user devices can be computer devices including some similar components as the device 1300, e.g., processor(s) 1302, memory 1304, and I/O interface 1306. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 1314, for example, can be connected to (or included in) the device 1300 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more operations described herein can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. field-programmable gate array (FPGA), complex programmable logic device), general purpose processors, graphics processors, application specific integrated circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the live feedback data for output (e.g., for display). In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method of a virtual-experience node, the computer-implemented method comprising:
obtaining, by a processor, an initial version of a set of tables associated with a region of a virtual experience, the region being associated with a set of virtual-experience models and virtual-experience scripts, the initial version of the set of tables being associated with an initial frame, each table in the set of tables comprising a plurality of rows, each of the plurality of rows corresponding to a portion of the region or a boundary portion that extends into an adjacent region of the virtual experience, each row containing information associated with a virtual object located in a corresponding portion of the region, and each row in the initial version of the set of tables including a first authority label and a first change marker;
simulating, by the processor, the initial frame of the region of the virtual experience based at least in part on the initial version of the set of tables;
generating, by the processor, an updated version of the set of tables associated with the region based on one or more first changes to a first virtual object in the region of the virtual experience, the updated version of the set of tables being associated with a subsequent frame, and each row in the updated version of the set of tables including a second authority label and a second change marker; and
simulating, by the processor, the subsequent frame of the region of the virtual experience based at least in part on the updated version of the set of tables.

2. The computer-implemented method of claim 1, further comprising:
maintaining, by the processor, the initial version and the updated version of the set of tables for a predetermined number of frames; and
deleting, by the processor, the initial version and the updated version of tables after the predetermined number of frames is reached.

3. The computer-implemented method of claim 1, wherein obtaining the initial version of a set of tables comprises:
generating a first row associated with the first virtual object, the first virtual object being an avatar associated with the virtual-experience node;
assigning the first row associated with the first virtual object a definitive authority label and an added change marker;
generating a second row associated with a second virtual object, the second virtual object being a non-avatar virtual object or another avatar associated with a different virtual experience node; and
assigning the second row associated with the second virtual object with a speculative authority label and the added change marker.

4. The computer-implemented method of claim 3, wherein generating the updated version of the set of tables comprises:
updating the first row associated with the first virtual object based on the one or more first changes;
assigning the first row associated with the first virtual object the definitive authority label and a changed-new change marker;
maintaining the second row associated with the second virtual object that is unchanged; and
assigning the second row associated with the second virtual object with the speculative authority label and an unchanged change marker.

5. The computer-implemented method of claim 4, further comprising:
sending, by the processor, a key and a delta value associated with the first row updated based on the one or more first changes to another virtual-experience node.

6. The computer-implemented method of claim 4, further comprising:
receiving, by the processor, a key and a delta value from another virtual-experience node, the key and the delta value indicating one or more second changes to the second virtual object occurred in the subsequent frame, and the key and the delta value including the definitive authority label;
identifying, by the processor, the second row in the updated version of the set of tables based on the key;
determining, by the processor, to update the second row in the updated version of the set of tables based on the speculative authority label;
generating, by the processor, another second row in the updated version of the set of tables based on the delta value;
assigning, by the processor, the another second row in the updated version of the set of tables with the speculative authority label and a changed-new change marker;
reassigning, by the processor, the second row associated with the second virtual object with the speculative authority label and a changed-old change marker; and
re-simulating, by the processor, the second virtual object in at least one frame based on the delta value.

7. The computer-implemented method of claim 4, further comprising:
receiving, by the processor, a key and a delta value associated with a third virtual object, wherein generating the updated version of the set of tables comprises:
determining, by the processor, the updated version of the set of tables does not include a third row associated with the third virtual object based on the key;
generating, by the processor, the third row associated with the virtual object based on the delta value; and
assigning, by the processor, the third row associated with the third virtual object the speculative authority label and the added change marker.

8. The computer-implemented method of claim 4, further comprising:
receiving, by the processor, a key and a delta value associated with the second virtual object that indicates the second virtual object is no longer located in the region associated with the virtual-experience node, wherein generating the updated version of the set of tables comprises:
generating, by the processor, another second row associated with the second virtual object based on the delta value; and
assigning, by the processor, the another second row associated with the second virtual object a speculative authority label and a deleted change marker.

9. The computer-implemented method of claim 1, further comprising:
determining, by a processor, a new region of the virtual experience is visible to an avatar associated with the virtual-experience node;
sending, by the processor, a request to a coordinator node for information associated with a different virtual-experience node that manages the new region;
receiving, by the processor, the information associated with the different virtual-experience node that manages the new region from the coordinator node;
requesting, by the processor, a set of replicated tables associated with the new region of the virtual experience from the different virtual-experience node; and
obtaining, by the processor, the set of replicated tables associated with the new region from the different virtual-experience node.

10. The computer-implemented method of claim 1, further comprising:
sending, by the processor, one or more of the initial version of the set of tables or the updated version of the set of tables to another virtual-experience node.

11. The computer-implemented method of claim 10, further comprising:
receiving, by the processor, a request for the one or more of the initial version of the set of tables or the updated version of the set of tables from the another virtual-experience node.

12. The computer-implemented method of claim 10, wherein sending the one or more of the initial version of the set of tables or the updated version of the set of tables to the another virtual-experience node occurs automatically at predetermined intervals.

13. The computer-implemented method of claim 11, further comprising:
assigning, by the processor, the initial version set of tables and the updated set of tables an authoritative marker;
obtaining, by the processor, a set of replicated tables associated with a different region of the virtual experience managed by another virtual-experience node; and
assigning, by the processor, the set of replicated tables a replicated marker.

14. The computer-implemented method of claim 11, further comprising:
maintaining, by the processor, a global directory that maps virtual objects to their respective regions in the virtual experience;
determining, by the processor, a script accesses a second virtual object located in a region associated with another virtual-experience node;
sending, by the processor, a read request associated with the second virtual object to the another virtual-experience node;
receiving, by the processor, a read response including information associated with the second virtual object from the another virtual-experience node; and
simulating, by the processor, another frame based on the information associated with the second virtual object from the read response.

15. The computer-implemented method of claim 11, wherein the virtual-experience node comprises a virtual-experience server or a client device.

16. A non-transitory computer-readable medium with instructions stored thereon that, when executed by one or more hardware processors of a virtual-experience node, cause the one or more hardware processors of the virtual-experience node to perform operations comprising:
obtaining an initial version of a set of tables associated with a region of a virtual experience, the region being associated with a set of virtual-experience models and virtual-experience scripts, the initial version of the set of tables being associated with an initial frame, each table in the set of tables comprising a plurality of rows, each of the plurality of rows corresponding to a portion of the region or a boundary portion that extends into an adjacent region of the virtual experience, each row containing information associated with a virtual object located in a corresponding portion of the region, and each row in the initial version of the set of tables including a first authority label and a first change marker;
simulating the initial frame of the region of the virtual experience based at least in part on the initial version of the set of tables;
generating an updated version of the set of tables associated with the region based on one or more first changes to a first virtual object in the region of the virtual experience, the updated version of the set of tables being associated with a subsequent frame, and each row in the updated version of the set of tables including a second authority label and a second change marker; and
simulating the subsequent frame of the region of the virtual experience based at least in part on the updated version of the set of tables.

17. The non-transitory computer-readable medium of claim 16, wherein obtaining the initial version of a set of tables comprises:
generating a first row associated with the first virtual object, the first virtual object being an avatar associated with the virtual-experience node;
assigning the first row associated with the first virtual object a definitive authority label and an added change marker;
generating a second row associated with a second virtual object, the second virtual object being a non-avatar virtual object or another avatar associated with a different virtual experience node; and
assigning the second row associated with the second virtual object with a speculative authority label and the added change marker.

18. The non-transitory computer-readable medium of claim 17, wherein generating the updated version of the set of tables comprises:
updating the first row associated with the first virtual object based on the one or more first changes;
assigning the first row associated with the first virtual object the definitive authority label and a changed-new change marker;
maintaining the second row associated with the second virtual object that is unchanged; and
assigning the second row associated with the second virtual object with the speculative authority label and an unchanged change marker.

19. The non-transitory computer-readable medium of claim 18, wherein the operations further comprise:
receiving a key and a delta value from another virtual-experience node, the key and the delta value indicating one or more second changes to the second virtual object occurred in the subsequent frame, and the key and the delta value including the definitive authority label;
identifying the second row in the updated version of the set of tables based on the key;
determining to update the second row in the updated version of the set of tables based on the speculative authority label;
generating another second row in the updated version of the set of tables based on the delta value;
assigning the another second row in the updated version of the set of tables with the speculative authority label and a changed-new change marker;
reassigning the second row associated with the second virtual object with the speculative authority label and a changed-old change marker; and
re-simulating the second virtual object in at least one frame based on the delta value.

20. A computing device of a virtual-experience node, comprising:
one or more hardware processors; and
a non-transitory computer readable medium coupled to the one or more hardware processors, with instructions stored thereon, that when executed by the one or more hardware processors, cause the one or more hardware processors to perform operations comprising:
obtaining an initial version of a set of tables associated with a region of a virtual experience, the region being associated with a set of virtual-experience models and virtual-experience scripts, the initial version of the set of tables being associated with an initial frame, each table in the set of tables comprising a plurality of rows, each of the plurality of rows corresponding to a portion of the region or a boundary portion that extends into an adjacent region of the virtual experience, each row containing information associated with a virtual object located in a corresponding portion of the region, and each row in the initial version of the set of tables including a first authority label and a first change marker;
simulating the initial frame of the region of the virtual experience based at least in part on the initial version of the set of tables;
generating an updated version of the set of tables associated with the region based on one or more first changes to a first virtual object in the region of the virtual experience, the updated version of the set of tables being associated with a subsequent frame, and each row in the updated version of the set of tables including a second authority label and a second change marker, and
simulating the subsequent frame of the region of the virtual experience based at least in part on the updated version of the set of tables.
